(19) United States
(12) Patent Application Publication
(10) Pub. No.: US 2024/0352610 A1
(43) Pub. Date: Oct. 24, 2024

(54) ELECTROCHEMICAL RECYCLING OF HOMOGENEOUS CATALYSTS

(71) Applicant: THE BOARD OF TRUSTEES OF THE UNIVERSITY OF ILLINOIS, Urbana, IL (US)

(72) Inventors: Xiao SU, Champaign, IL (US); Stephen COTTY, Champaign, IL (US)

(73) Assignee: THE BOARD OF TRUSTEES OF THE UNIVERSITY OF ILLINOIS, Urbana, IL (US)

(21) Appl. No.: 18/685,739

(22) PCT Filed: Apr. 20, 2022
(86) PCT No.: PCT/US2022/025467

§ 371 Date: Feb. 22, 2024

Related U.S. Application Data
(60) Provisional application No. 63/237,364, filed on Aug. 26, 2021.

(51) Int. Cl. C25C 1/20; B01J 38/48

(52) U.S. Cl. CPC C25C 1/20; B01J 38/485

(57) ABSTRACT

Herein disclosed is a new electrochemical approach to catalyst capture and recycling that overcomes conventional industrial recovery methods using functionalized redox-polymer electrodes. This technology provides a redox electro-separation system comprising polyvinylferrocene that was able to capture platinum group metal based catalysts directly from products and transfer to fresh reactants achieving 99.5% recovery without disturbing catalyst activity. Several reactions were tested along with various solvent-electrolyte matrices, showing >99% recovery efficiencies for platinum species as low as 1.6 ppm.

### RELATED APPLICATIONS

This application claims priority under 35 U.S.C. § 119 (c) to U.S. Provisional Patent Application No. 63/237,364 filed Aug. 26, 2021, which is incorporated herein by reference.

### BACKGROUND OF THE INVENTION

Homogeneous catalysts are known for their remarkable turnover, selectivity, and versatility, making them the systems of choice for a range of important reactions. Single-site homogeneous catalysts enable precise control over reaction pathways through synthetic design, for key reactions in chemical and pharmaceutical manufacturing. However, heterogeneous catalysis makes up around 75% of chemical and petrochemical processes in industry. Catalyst homogeneity can be a double-edged sword; while single-site molecular catalysts show superior kinetics and selectivity, separating these catalysts from the product mixtures can be challenging, posing significant challenges for economical re-use. Moreover, homogeneous catalysts often consist of platinum group metals (PGMs), which are valuable critical elements.

For example, platinum catalyzed hydrosilylation is a cornerstone for the organosilicon industry, with a market size valued at $1.1 billion USD in 2019. The recovery of homogeneous platinum catalysts from silane product mixtures is a prominent challenge in chemical manufacturing, with the platinum from catalysts accounting for up to 30% of the production cost of silicones. The high viscosity and boiling points of hydrosilylation products make traditional recovery methods such as distillation extremely costly. While there have been efforts to find earth-abundant alternatives such as Fe, Co, and Ni complexes, platinum-based hydrosilylation catalysts still monopolize the industry due to their unmatched atomic efficiency and kinetics, despite the drawbacks. Similarly, palladium catalyzed cross-coupling reactions have rapidly seen the leap from lab-scale organic chemistry to industrial synthesis. Recovery of dilute palladium catalysts (<20 ppm) remains a central problem due to excess competing salts (base and stabilizers) in the product solution. Furthermore, these Pd-catalysts contain sensitive ligands, making non-destructive recovery an arduous challenge.

Therefore, enabling efficient homogeneous catalyst recycling is central for increasing feasibility of these highly active and tunable homogeneous catalysts. Current catalyst recovery techniques based on thermal or chemical methods can be energetically demanding, or require laborious downstream processing. Distillation is the most common catalyst recovery technique in industry currently. However, distillation has a limited scope of economic feasibility for reaction systems with low boiling point products, and thermally stable catalysts, making them inefficient for the sensitive Pt and Pd homogeneous catalysts. Furthermore, homogeneous catalysis typically operate in the parts-per-million range for catalyst concentration due to high turnover numbers and the high cost of the catalysts, making thermal recovery methods even more costly and carbon intensive.

Electrification of chemical manufacturing offers a key pathway carbon-neutrality, and electrochemical separations can play a key role in this mission. “Plug and play” electrochemical platforms can lower chemical and energy costs by field-assisted control and facilitate integration with renewable energy. However, major electrochemical separation processes such as capacitive deionization and electrodeposition have significant challenges for fine process synthesis purification, due to a lack of molecular selectivity and dependence on high voltages. On the other hand, redox-active polymers have gained intense attention as a promising for selective platform ion separations. Redox-active materials have longtime been the focus of energy storage, electrocatalysis, and electrochemical sensing, yet recently have been explored for electrochemical separations due to their selective molecular interactions and electrochemical reversibility. However, most of their applications have been for aqueous phase contaminant removal, with this powerful concept yet to be applied and generalized for value-added recovery of catalysts from organic solutions.

As recycling of valuable homogeneous catalysts remains a critical challenge, an electrochemical approach to economical homogeneous catalyst recycling of noble metal catalysts based purely on electric potential is needed.

### SUMMARY

Homogeneous catalysts are known for having rapid kinetics and keen reaction selectivity, however economical catalyst recyclability remains a critical hurtle. Herein is disclosed a new electrochemical approach to catalyst capture and recycling that overcomes conventional industrial recovery methods using functionalized polyvinylferrocene electrodes. Our redox electro-separation system was able to capture platinum-based hydrosilylation catalysts directly from products (uptake of the active catalyst >200 mg/g) and transfer to fresh reactants achieving 99.5% recovery—all without disturbing catalyst activity. Several reactions are tested along with various solvent-electrolyte matrices, and our system shows >99% recovery efficiencies for platinum species as low as 1.6 ppm. Lastly, we investigate scale-up with continuous flow and conduct a technoeconomic analysis. We find that redox-active materials show great potential as an economical means to electrochemical homogeneous catalyst recovery.

Accordingly, this disclosure also provides a method for electrochemically recycling a noble metal catalyst comprising:
a) applying a positive first potential to a working electrode comprising a redox metallopolymer wherein the metal moieties of the redox metallopolymer are transformed to an oxidized metal species and form an oxidized metallopolymer electrode;
b) contacting a product mixture and the oxidized metallopolymer electrode wherein the mixture comprises a reaction product and a noble metal catalyst;
c) selectively adsorbing the catalyst to the oxidized metallopolymer electrode wherein the noble metal moiety of the catalyst binds to the oxidized metal species and forms a loaded electrode;
d) collecting the reaction product when the catalyst is adsorbed to the oxidized metallopolymer electrode;
e) contacting an electrolyte and the loaded electrode;
f) applying a second potential to the loaded electrode wherein the second potential is less relative to the first potential by at least 0.1 V and the oxidized metal species is transformed to a reduced state;
g) desorbing the adsorbed noble metal catalyst from the loaded electrode into the electrolyte; and
h) contacting the desorbed noble metal catalyst and an organic substrate to form the product mixture;
   wherein the noble metal catalyst is thereby electrochemically recycled from the reaction mixture.

Also, this disclosure provides an electrochemical apparatus for recycling a noble metal catalyst comprising:
a) at least one working electrode, each working electrode comprising a current collector, conductive binder, and a redox metallopolymer wherein the redox metallopolymer is a selective binder and reversible binder of a noble metal catalyst;
b) at least one counter electrode;
c) a variable potentiostat;
d) a reaction chamber; and
e) a flow inlet and a flow outlet.

In some embodiments, the apparatus comprises a first and second working electrode and a first and second counter electrode, wherein a first cell comprises the first working electrode and one of the first or second counter electrodes, and a second cell comprises the second working electrode and one of the first or second counter electrodes

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. (a) Redox-mediated electrochemical recycle of organometallic catalysts. (b) Pt 4f XPS spectra of PVF-CNT electrodes after adsorption of Speier's catalyst for a range of applied potentials. (c) Corresponding uptake of Speier's catalyst for a range of potentials, and representative Pt speciation from XPS. (d) Regeneration efficiency of Speier's catalyst over a range of reduction potentials. Speier's catalyst was initially adsorbed at 0.5V vs Ag/AgCl. (e) Corresponding Pt 4f XPS spectra of the PVF-CNT electrodes after desorption. (f) Top-left: a photo of a PVF-CNT electrode. Top-right/Bottom-left: SEM/EDS spectra of PVF-CNT electrodes following adsorption of Pt and Pd catalyst. Bottom-right: high resolution SEM of PVF-CNT electrode.

FIG. 2. (a) Comparative catalyst recycle performance of the PVF-CNT electrosorption system for the four model reactions tested, with red line representing full catalyst activity retention. (b) Comparison of the reaction kinetics of silane etherification (using EtOH and TES) with electrochemically recycled Speier's catalyst to a control using as-received catalyst. (c) Catalyst recovery performance from silane etherification reactions using various reactant substrates. A series of (alcohols methanol (MeOH), isopropanol (IPA), diacetone alcohol (DAA), and ethanol (EtOH)) were used along with different silanes (triethylsilane (TES) and dimethylphenylsilane (DMPS)). (d) Catalyst recycling performance over 7 cycles, for silane etherification with the model reaction using EtOH and TES.

FIG. 3. Predicted Gibbs binding energy by DFT of Speier's, Wacker, and Suzuki catalysts relative to supporting electrolyte for each reaction system (ClO₄⁻ for Speier and Cl⁻ for Wacker and

Suzuki).

FIG. 4. (a) Schematic diagram of the inline ICP-OES for monitoring Speier's catalyst concentration in flow-by cell. (b) Electrochemical voltage input (top) and current response (bottom) during electrosorption. (c) Diagram of the flow-by cell with PVF-CNT coating on anode during catalyst separation. (d) Real-time monitoring of Speier's catalyst adsorption and release for flow-cell.

FIG. 5. (a) Schematic diagram of a continuously operated catalyst recovery system. (b) Comparison of the standard potential of PVF the redox potential (right line), platinum electrodeposition potential (left line), and the measured electrochemical window of stability for selected reaction solvents. (c) Catalyst recycle performance in the selected industrial solvents. (d) Electrochemical separation performance for platinum group metal chloroanions. (e) Electrosorption isotherm of Speier's catalyst in ethanol (bottom line) and corresponding catalyst release efficiency (top line). (f) PVF-CNT cycling performance over 4671 charge/discharge cycles in ethanol. Inlaid figure depicts a CV of the electrode before and after cycling. (g) Estimated cost to recycle Speier's (solid lines) and Karstedt's (dashed lines) per the concentration of catalyst exiting the reactor for 3 catalyst recovery methods: PVF adsorption, distillation, and electrodeposition.

FIG. 6. Binding energy of Fc⁺ with (a) Speier's catalyst system (b) Wacker catalyst system (c) Suzuki coupling catalyst system. (d) Binding energy of Fc⁺ with Speier's catalyst with respect to solvent dielectric constant.

FIG. 7. (a) Platinum XPS 4f spectra of various platinum species controls. Chloroplatinic acid (top) shows a Pt(IV) peak at 75 eV and a Pt(II) peak at 73 eV due to light degradation. Speier's catalyst shows only a Pt(II) peak, and pure platinum metal shows an asymmetrical Pt(0) peak at 71 eV. (b) Platinum XPS 4f spectra of carbon paper electrodes after adsorption over a range of applied potentials (applied potential is the PVF-CNT working electrode versus Ag/AgCl reference). Electrodeposited Pt(0) begins to form at potentials above 0.5V (top region). Only trace Pt(II) is found at a working potential below 0.4V (middle and bottom regions).

FIG. 8. XPS spectra of PVF-CNT electrodes (black lines) and counter electrodes (grey lines) after adsorption (top region) and desorption (bottom region) for the following reaction-catalyst systems: (a) Speier's catalyst Silane etherification of Triethylsilane and ethanol. Note that XPS analysis was done on electrodes after 7 consecutive recycle procedures. (b) Speier's catalyst Hydrosilylation of Triethylsilane and phenylacetylene. (c) PdCl₂ (PPh₃)₂ catalyst Suzuki cross-coupling of phenylboronic acid and 4-bromoacetophenone.

FIG. 9. a) Iron XPS spectra of PVF-CNT electrodes after adsorption at various potentials (0.2V to 1V vs Ag/AgCl). The only Iron source on electrodes is the Fe center of ferrocene. Fe(II) (seen at 705 eV) represents reduced ferrocene, and Fe(III) (seen at 709 eV) represents oxidized ferrocenium. b) quantitative representation of the iron oxidation state from XPS data for PVF-CNT electrodes after adsorption at various potentials. Iron rapidly oxidizes beyond 0.4V vs Ag/AgCl.

FIG. 10. Iron XPS spectra of PVF-CNT working electrodes after desorption of Speier's catalyst in ethanol. Fe(II) peak at 705 eV represents fully reduces ferrocene sites, and Fe(III) peak at 708 eV represents oxidized ferrocenium. Only faint trace of ferrocenium is observed at +0.3V vs Ag/AgCl, and full ferrocene reduction is observed for all other potentials.

FIG. 11. (a) 4f XPS spectra for the carbon paper counter electrodes after Speier's catalyst desorption at various desorption potentials (adsorption was at +0.5V vs Ag/AgCl). Pt(II) is the only species present meaning no Pt reduction occurred regardless of potential. The Working electrode at +0.3V is the only sample that shows a strong Pt(II) signal indicating incomplete release of adsorbed catalyst. (b) XPS Survey spectra of PVF-CNT electrode after adsorption of Speier's catalyst in Hydrosilylation.

FIG. 12. Palladium XPS spectra. (a) dried palladium salt controls. Metallic Pd shows an asymmetrical peak at 335 eV corresponding to Pd(0). PdCl₂. K₂PdCl₄ and PdCl₂ (PPh₃)₂ showed a peak at 337.5 eV corresponding to Pd(II). K₂PdCl₆ showed a peak at 339.5 eV corresponding to Pd(IV). (b) Palladium XPS spectra of PVF-CNT working electrodes after adsorption over a range of applied potentials (vs Ag/AgCl). Above 0.4V, only Pd(II) is observed on the electrode. Below 0.2V. electrodeposited Pd(0) begins to appear. (c) Comparison of both PVF-CNT working electrode (black) and counter electrode (grey) after adsorption (top region) at 0.6V and desorption (bottom region) at +0.1V. No Pd was ever observed on the carbon paper counter electrode, and only Pd(II) was observed after adsorption and desorption.

FIG. 13. (a) Cyclic voltammogram of chloroplatinic acid (5 mM) in water with 20 mM NaClO₄ supporting electrolyte. The first cycle shows the onset of Pt electrodeposition at −0.2V and cycles in a counterclockwise “rotation” signifying deposited Pt on electrode surface catalyzes further Pt electrodeposition. This is further evident on subsequent cycles where the overpotential of platinum deposition is lowered and occurs around +0.2V vs Ag/AgCl. (b) Cyclic voltammogram of 5 mM chloroplatinic acid in water with 20 mM NaClO₄ supporting electrolyte. A narrow potential window is chosen (between 0.1V and 0.6V vs Ag/AgCl) and cycled 100 times. Platinum electrodeposition is significantly inhibited by the narrow potential window. (c) Voltammogram of ethanol stability window. 50 mV/s scan rate with carbon paper working and counter electrodes. Ethanol electro-degradation is observed at potential >1.3V and <−0.4V vs Ag/AgCl. (d) Current collector material study where the goal was to find a material that inhibits platinum electrodeposition over the widest range of potentials. Toray 030 carbon paper with 5% Teflon coating was chosen.

FIG. 14. Cyclic voltammogram of PVF-CNT electrode in ethanol solution of 20 mM NaClO₄ (right) and carbon paper electrode in 5 mM chloroplatinic acid in ethanol (left).

FIG. 15. Chronoamperometric data from 1 mM Speier's catalyst adsorption experiments in ethanol over a range of applied potentials. (a) Cumulative charge, (b) current, and (c) overall cell potential vs time for each applied potential. The (d) average counter electrode potential and (e) energy consumption versus applied potential is shown.

FIG. 16. The energy consumed during Speier's catalyst desorption normalized by PVF mass at various desorption potentials.

FIG. 17. Energy consumption during adsorption (grey, left bar) and desorption (black, right bar) for various solvents and electrolytes.

FIG. 18. Normalized accumulative charge Q (Q/Q₀) over cyclic voltammetry cycles. The very first cycles were disregarded. Solid lines are with 0 w % crosslinker and dotted lines with 20 w % crosslinker (20% CL). The grey bars represent the normalized accumulative charge at the fifth cycle.

FIG. 19. Solution conductance of two different solutions as Karstedt's catalyst is added and left to equilibrate. Ethanol (bottom line) shows very little increase in solution conductivity as catalyst is added. Silane etherification product solution (top line) initially containing 2:1 ethanol and triethylsilane shows a sharp linear increase in solution conductivity as Karstedt's catalyst is added and allowed to equilibrate. Conductivity measurements were taken with two carbon paper electrodes in parallel 1 cm apart with each electrode having an exposed area of 1 cm by 1 cm.

FIG. 20. a) UV-VIS spectroscopy spectra of triethylsilane etherification reaction with ethanol catalyzed with 30 ppm Speier's catalyst. At the 8-minute line (arrow) the reaction has ended. The noise observed at 1,4, and 8 minutes is due to hydrogen bubble formation. UV-VIS spectra is featureless except for a peak at 360 nm and a faint peak at 460 nm. The 360 nm peak has been observed as the active platinum catalyst species for hydrosilylation. The 360 nm peak is most distinctly observed in our work when silane etherification reaction progresses. b) Comparison of UV-VIS spectra directly before adsorption from the control reaction (top line) and directly after desorption into fresh reactants (bottom line).

FIG. 21. Wacker catalyst recycle optimization. All experiments used an initial Palladium solution contained 1 mM PdCl₂ and 20 mM CuCl₂ in 7:1 methanol/water. a) Palladium uptake over a range of applied potentials with PVF-CNT as the working electrode. b) Palladium uptake without PVF on the working electrode at 0.0V and 0.6V vs Ag/AgCl. c) Uptake and recovery efficiency of in situ wacker catalyst recycle with PVF-CNT (left panel) and without PVF (right panel). d) voltammogram of K₂PdCl₄ in methanol showing palladium electrodeposition and stripping. e) voltammogram of CuCl₂ showing redox behavior. f) Palladium uptake kinetics with PVF-CNT electrode at 0.6V over the span of 50 minutes.

FIG. 22. Cross-coupling catalyst recycle optimization. a) cyclic voltammogram electrochemical stability study of each individual Suzuki cross-coupling component. No redox behavior is observed for any component. b) cyclic voltammogram of PVF-CNT electrode in Suzuki coupling reaction solution to verify PVF electrode stability in cross-coupling environment. c) cyclic voltammogram of 2 mM PdCl₂ (PPh₃)₂ and 300 mM TBABF4 in THF. Pd reduction to a stable anionic Pd(0) complex is observed at −1.5V vs Ag/AgNO₃. d) Comparison of uptake and regeneration efficiency between as received PdCl₂ (PPh₃)₂ and after being reduced to an anionic Pd(0) form. Higher uptake is observed when in anionic form.

FIG. 23. Inlet (black, dashed line) and outlet (solid line) Speier's catalyst concentrations from flow-by cell. From 0 to 6.4 minutes, and oxidizing potential was applied and catalyst was adsorbed-shown by the outlet concentration being lower than the inlet concentration. From 6.4 minutes to 10.4 minutes, a reducing potential was applied and catalyst was released-shown by the outlet concentration being higher than the inlet concentration.

### DETAILED DESCRIPTION

Homogeneous catalysts possess rapid kinetics and keen reaction selectivity. However, their widespread use for industrial catalysis has remained limited due to challenges in re-usability. Here, we propose a redox-mediated electrochemical approach for catalyst recycling using metallopolymer functionalized electrodes for binding and release, overcoming limitations of conventional industrial recycling methods. The redox-electrochemical platform was investigated for the separation of key platinum and palladium homogeneous catalysts used in organic synthesis and industrial chemical manufacturing. Noble-metal catalysts for hydrosilylation, silane etherification, Suzuki cross-coupling, and Wacker oxidation were recycled electrochemically in a range of industrially relevant reaction conditions. The redox-electrodes demonstrated high sorption uptake (>200 mg Pt/g adsorbent) from product mixtures, with over 99.5% recovery, whilst retaining full catalytic activity over multiple cycles. The combination of mechanistic studies and electronic structure calculations indicate that selective interactions with charged intermediates during the catalytic cycle played a key role in separations. Lastly, continuous flow-cell studies support the scalability and superior technoeconomics to traditional thermal catalytic recovery methods. The work provides a sustainable electrochemically-driven approach for achieving homogeneous catalyst recovery.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14th Edition, by R. J. Lewis, John Wiley & Sons, New York, N. Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely.” “only.” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in various embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient. composition, or embodiment. The terms “about” and “approximately” can also modify the end-points of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3 . . . 9.8. 9.9, 10.0, and also means 1.01. 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above.

The recitation of a), b), c), . . . or i), ii), iii), or the like in a list of components or steps do not confer any particular order unless explicitly stated or implied.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture.

An “effective amount” refers to an amount effective to bring about a recited effect, such as an amount necessary to form products in a reaction mixture. Determination of an effective amount is typically within the capacity of persons skilled in the art, especially in light of the detailed disclosure provided herein. The term “effective amount” is intended to include an amount of a compound or reagent described herein, or an amount of a combination of compounds or reagents described herein. e.g., that is effective to form products in a reaction mixture. Thus, an “effective amount” generally means an amount that provides the desired effect.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including.” “containing.” or “characterized by.” and is inclusive or open-ended and does not exclude additional, unrecited elements or method steps. As used herein. “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”. “consisting essentially of” and “consisting of” may be replaced with either of the other two terms. The disclosure illustratively described herein may be suitably practiced in the absence of any element or elements, limitation or limitations which is not specifically disclosed herein.

This disclosure provides methods of making the compounds and compositions of the invention. The compounds and compositions can be prepared by any of the applicable techniques described herein, optionally in combination with standard techniques of organic synthesis. Many techniques such as etherification and esterification are well known in the art. However, many of these techniques are elaborated in Compendium of Organic Synthetic Methods (John Wiley & Sons, New York), Vol. 1, Ian T. Harrison and Shuyen Harrison, 1971; Vol. 2, Ian T. Harrison and Shuyen Harrison, 1974; Vol. 3, Louis S. Hegedus and Leroy Wade, 1977; Vol. 4, Leroy G. Wade, Jr., 1980; Vol. 5, Leroy G. Wade, Jr., 1984; and Vol. 6; as well as standard organic reference texts such as March's Advanced Organic Chemistry: Reactions, Mechanisms, and Structure, 5th Ed., by M. B. Smith and J. March (John Wiley & Sons, New York, 2001); Comprehensive Organic Synthesis. Selectivity, Strategy & Efficiency in Modern Organic Chemistry. In 9 Volumes, Barry M. Trost, Editor-in-Chief (Pergamon Press, New York, 1993 printing); Advanced Organic Chemistry, Part B: Reactions and Synthesis, Second Edition, Cary and Sundberg (1983); for heterocyclic synthesis see Hermanson, Greg T., Bioconjugate Techniques, Third Edition, Academic Press, 2013.

The term “halo” or “halide” refers to fluoro, chloro, bromo, or iodo. Similarly, the term “halogen” refers to fluorine, chlorine, bromine, and iodine.

The term “alkyl” refers to a branched or unbranched hydrocarbon having, for example, from 1-20 carbon atoms, and often 1-12, 1-10, 1-8, 1-6, or 1-4 carbon atoms; or for example, a range between 1-20 carbon atoms, such as 2-6, 3-6, 2-8, or 3-8 carbon atoms. As used herein, the term “alkyl” also encompasses a “cycloalkyl”.

As used herein, the term “substituted” or “substituent” is intended to indicate that one or more hydrogens on the group indicated in the expression using “substituted” (or “substituent”) is replaced a functional group(s), i.e., a suitable group known to those of skill in the art, provided that the indicated atom's normal valency is not exceeded, and that the substitution results in a stable compound.

A “solvent” as described herein can include water or an organic solvent. Examples of organic solvents include hydrocarbons such as toluene, xylene, hexane, and heptane; chlorinated solvents such as methylene chloride, chloroform, and dichloroethane; ethers such as diethyl ether, tetrahydrofuran, and dibutyl ether; ketones such as acetone and 2-butanone; esters such as ethyl acetate and butyl acetate; nitriles such as acetonitrile; alcohols such as methanol, ethanol, and tert-butanol; and aprotic polar solvents such as N,N-dimethylformamide (DMF), N,N-dimethylacetamide (DMA), and dimethyl sulfoxide (DMSO). Solvents may be used alone or two or more of them may be mixed for use to provide a “solvent system”.

The term, “repeat unit”, “repeating unit”, or “block” as refers to the moiety of a polymer that is repetitive. The repeat unit may comprise one or more repeat units covalently bound together to form a combined repeat unit. Monomers or a combination of one or more different monomers can be combined to form a (combined) repeat unit of a polymer or copolymer.

As used herein, the term “redox metallopolymer” refers to a polymer comprising a redox species, such as an organometallic functional group that can be oxidized and/or reduced during or upon electrical stimulation (e.g., during or upon application of an electrical potential), or can undergo a Faradaic reaction. For example, a redox species comprises one or more molecular moieties that accept and/or donate one or more electrons depending on its redox state. A redox metallopolymer may be applied, in combination with other additives such as a binder, to a surface such as a current collector, to form a working electrode such as redox metallopolymer electrode.

The term “polyferrocene” or “polymetallocene” refers to polymers comprising ferrocene or metallocene units along an orgnaic polymer backbone. Repeat units of the polymer include a covalently bonded ferrocene or metallocene moiety. The polyferrocene or polymetallocene may comprise substituents, such as a halo, alkyl, carboxyl moiety, or other substituents.

The term “redox species” refers to a metallocene such as ferrocene. Upon application of an electrical potential of the working electrode, the redox species is oxidized and captures target ions through, for example, Coulombic attraction of a target metal or metal ion. In various embodiments where the redox species is a metallocene, the selectivity relies on the direct interaction of the target metal ion with the cyclopentadienyl ring of the metallocene. The captured target metal ions can be subsequently released or desorbed by reversal (partial or complete, including V=0) of the applied electrical potential. In various embodiments the adsorption/desorption occurs with minimal or no pH, temperature, or other changes in solution condition.

The term “target” refers to the metal (e.g., a noble metal) of a catalyst that is amenable for separation using the electrochemical devices or systems or methods described herein. The catalyst can be a charged molecule (e.g., an ion) or a neutral molecule.

The term “reversible” refers to binding, adsorption, or attachment of a metal ion species (e.g., the metal of a catalyst) onto an electrode surface being reversible by modulation of an electrical potential applied across electrodes. For example, an organometallic catalyst can bind, adsorb, or attach onto an electrode surface upon application of an electrical potential, and can then be released from the electrode surface by reversing the electrical potential.

When referring to a cylinder's axis, this means the segment containing the centers of the two bases where the axis is perpendicular to the planes of the two bases, such as in a right cylinder. Each base (or end) of the cylinder may be open or closed, and the cylinder may be hollow or solid and circular or elliptical.

The phrase “various embodiments” as used herein means the disclosed technology is envisioned to be in combination with any one or more various embodiments recited herein.

### Embodiments of the Technology

This disclosure provides a method for electrochemically recycling a noble metal catalyst comprising:
a) applying a positive first potential to a working electrode comprising a redox metallopolymer wherein the metal moieties of the redox metallopolymer are transformed to an oxidized metal species and form an oxidized metallopolymer electrode;
b) contacting a product mixture and the oxidized metallopolymer electrode wherein the mixture comprises a reaction product and a noble metal catalyst;
c) selectively adsorbing the catalyst to the oxidized metallopolymer electrode wherein the noble metal moiety of the catalyst binds to the oxidized metal species and forms a loaded electrode;
d) collecting the reaction product when the catalyst is adsorbed to the oxidized metallopolymer electrode;
e) contacting an electrolyte and the loaded electrode;
f) applying a second potential to the loaded electrode wherein the second potential is less relative to the first potential by at least 0.1 V and the oxidized metal species is transformed to a reduced state;
g) desorbing the adsorbed noble metal catalyst from the loaded electrode into the electrolyte; and
h) (optionally) contacting the desorbed noble metal catalyst and an organic substrate to form the product mixture;
   wherein the noble metal catalyst is thereby electrochemically recycled from the reaction mixture.

Additionally, this disclosure provides a method for electrochemically recycling a metal catalyst comprising:
a) applying a positive first potential to a polyferrocene electrode wherein iron moieties of the polyferrocene electrode are transformed to an oxidized ferrocenium species and form an oxidized polyferrocene electrode;
b) contacting a product mixture and the oxidized polyferrocene electrode wherein the mixture comprises a reaction product and a metal catalyst;
c) selectively adsorbing the metal catalyst to the oxidized polyferrocene electrode wherein the metal moiety of the catalyst binds to the ferrocenium species and forms a loaded electrode;
d) collecting the reaction product when the metal catalyst is adsorbed to the oxidized polyferrocene electrode;
e) contacting an electrolyte and the loaded electrode;
f) applying a second potential to the loaded electrode wherein the second potential is less relative to the first potential by at least 0.1 V and the ferrocenium species are transformed to a reduced state;
g) desorbing the adsorbed metal catalyst into the electrolyte from the loaded electrode; and
h) contacting the desorbed metal catalyst and an organic substrate to form the product mixture;
   wherein the metal catalyst is thereby electrochemically recycled from the reaction mixture.

In various embodiments of working electrodes described herein (such as a polyferrocene electrode), the redox species in an oxidized state selectively binds to a metal or metal ion (e.g., preferential binding to a catalyst over electrolytes and other molecules in a mixture) by at least about 1.1-fold, at least about 1.5-fold, at least about 2-fold, at least about 3-fold, at least about 4-fold, at least about 5-fold, at least about 10-fold, at least about 25-fold, at least about 50-fold, at least about 100-fold, at least about 200-fold, at least about 300-fold, at least about 400-fold, at least about 500-fold, at least about 1000-fold or more.

In various embodiments, the redox metallopolymer is metallocene polymer. In various embodiments, the metal moieties of the redox metallopolymer are iron, cobalt, chromium, nickel, or vanadium. In various embodiments, the redox metallopolymer is a polyferrocene or a cobaltocene.

In various embodiments, the polyferrocene, or working electrode comprises, a coating of polyvinylferrocene (PVF), poly 2-(methacryloyloxy) ethyl ferrocene carboxylate (PFCMA), poly (ferrocenylsilane) (PFS), poly (ferrocenylmethyl methacrylate) (PFMMA), or other derivatives of metallopolymers. In various embodiments, the working electrode comprises a multiwalled carbon nanotube (CNT) binder. In various embodiments the ratio of the metallopolymer or metallocene and binder (e.g., metallocene:binder) is about 3:1, about 2:1, about 1.5:1, about 1.25:1, about 1:1, about 1:1.25, about 1:1.5, about 1:2, or about 1:3.

In various embodiments, one or more metal moieties of the redox metallopolymer are transformed to an oxidized metal species and form a partially oxidized or fully oxidized metallopolymer electrode. In various embodiments, one or more oxidized metal species of the oxidized metallopolymer are transformed to a reduced metal species and form a partially reduced or fully reduced metallopolymer electrode.

In various embodiments, the noble metal catalyst is soluble in an organic or aqueous solution, and in their charged state, can be recovered by the working electrode disclosed herein. In various embodiments, the product mixture comprises a solvent. In various embodiments, the solvent is water, methanol, ethanol, dimethylformamide, acetonitrile, acetone, tetrahydrofuran, or a combination thereof.

In various embodiments, the working electrode comprises a current collector that is polytetrafluoroethylene coated carbon paper, graphite, graphene sheet, titanium, or stainless steel. In various embodiments, the first potential is about +0.3 V to about +2.0 V, about +0.3 V to about +0.6 V, about +0.2 V to about +0.7 V, about +0.1 V to about +0.8 V, or about +0 V to about +0.9 V. wherein the first potential is relative to an Ag/AgCl reference electrode. In various embodiments, the second potential is about −1 V to about +0.3 V, about −0.1 V to about +0.2 V. about −0.2 V to about +0.1 V. about −0.3 V to about +0 V, about −0.4 V to about −0.1 V, or about −0.5 V to about −0.2 V. wherein the second potential is relative to an Ag/AgCl reference electrode.

In various embodiments, the noble metal moiety of the noble metal catalyst is platinum, palladium, iridium, ruthenium, rhodium, or osmium. In various embodiments, the noble metal catalyst is chloroplatinic acid, chloroplatinic acid-isopropanol complex (Speier's catalyst), platinum(0)-1,3-divinyl-1,1,3,3-tetramethyldisiloxane complex (Karstedt's catalyst), potassium tetrachloropalladate(II) (K₂PdCl₄), palladium(II) chloride (PdCl₂), (PdCl₂(PPh₃)₂), bis(triphenylphosphine)palladium(II) dichloride (Pd(PPh₃)₄), palladium(II) acetate (Pd(OAc)₂), Na₂PdCl₄, H₃IrCl₆, Na₃RhCl₆, or Na₂RuCl₅NO.

In various embodiments, the noble metal catalyst undergoes electrodeposition to the extent of less than about 20 wt. %, less than about 15 wt. %, less than about 10 wt. %, less than about 5 wt. %, less than about 4 wt. %, less than about 3 wt. %, less than about 2 wt. %, less than about 1 wt. %, or less than about 0.5 wt. % of the noble metal catalyst.

In various embodiments, the electrolyte comprises aluminum chloride, lithium chloride, sodium perchlorate, lithium perchlorate, or tetrabutylammonium perchlorate (TBAP), potassium chloride, sodium chloride, sodium acetate, CuCl, CuCl2, tetrabutylammonium chloride, or tetrabutylammonium bromide. In various embodiments, the electrolyte comprises suitable reactants; and contact of the suitable reactants and the noble metal catalyst forms the product mixture. In various embodiments, the reaction product is a product of silane etherification, hydrosilylation reaction, cross-coupling, or Wacker oxidation.

Also, this disclosure provides an electrochemical apparatus for recycling a noble metal catalyst comprising:
a) at least one working electrode, each working electrode comprising a current collector, conductive binder, and a redox metallopolymer wherein the redox metallopolymer is a selective binder and reversible binder of a noble metal catalyst;
b) at least one counter electrode;
c) at least one electrical power source or at least one variable potentiostat;
d) a reaction chamber or a plurality of reaction chambers; and
e) an optional flow inlet and an optional flow outlet.

In various embodiments, the redox metallopolymer is cross-linked. In various embodiments, the redox metallopolymer comprises a polyferrocene, and the conductive binder comprises a multiwalled carbon nanotube, single-walled carbon nanotube, activated carbon, graphite, or graphene. In various embodiments, the current collector and the least one counter electrode each comprise a polytetrafluoroethylene coating. In various embodiments, the current collector and/or the least one counter electrode is a conductive material, carbon paper, graphite, graphene, carbon fiber, steel, aluminum, titanium, platinum.

In various embodiments, the apparatus comprises a first and second working electrode and a first and second counter electrode, wherein a first cell comprises the first working electrode and one of the first or second counter electrodes, and a second cell comprises the second working electrode and one of the first or second counter electrodes. In various embodiments, the first cell and second cell are in series or in parallel. In various embodiments, one or more cells are in series, in parallel, or a combination thereof. In various embodiments, the apparatus comprises two or more cells. In various embodiments, the apparatus comprises three cells, four cells, five cells, six cells, seven cells, eight cells, nine cells, or ten cells.

In various embodiments, the first and second working electrodes are positioned sequentially and encompass the cylindrical surface of an electrically conductive cylinder that is rotatable on its axis, wherein the cylinder is positioned between the first and second counter electrode.

In various embodiments, the reaction chamber has an inlet in (fluid) communication with the first cell and an outlet in communication with the second cell. In various embodiments, the first cell has the flow inlet, and the second cell has the flow outlet. In various embodiments, the apparatus comprises two or more reaction chambers. In various embodiments, the electrical power source or potentiostat is configured to switch or cycle the potential of the working electrode from a first voltage to a second voltage.

### Results and Discussion

In this work, we developed a benign electrochemical separation platform based on redox-metallopolymer coated electrosorbents for the in-situ recycling of industrially relevant homogeneous platinum group metal (PGM) catalysts: Speier's catalyst, Karstedt's catalyst, palladium chloride, bis (triphenylphosphine) palladium dichloride, and other PGM chloro-complexes. We investigated the performance of our redox-separation platform for platinum-catalyzed hydrosilylation and silane etherification, as well as palladium-catalyzed Wacker oxidation and Suzuki cross-coupling (Scheme 1). Our work demonstrates the powerful generality of our proposed electrochemical recycling concept towards both industrially relevant reactions as well as major classes of metal-catalyzed organic synthesis. Central to the study is the preservation of catalytic structure and activity, driven solely by electrochemical control without Faradaic destruction of the catalysts. Electronic structure calculations and spectroscopy provide insights into the catalyst binding modes. Finally, we demonstrate the superior technoeconomic advantages of electrochemical homogeneous catalyst recycling, and the scalability of the process in a continuous flow process.

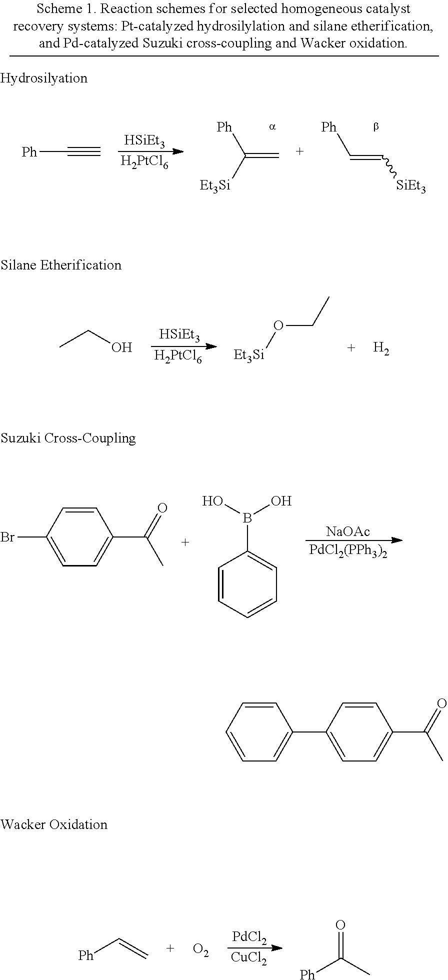

### Redox-Mediated Electrosorption for Reversible Catalyst Recycling

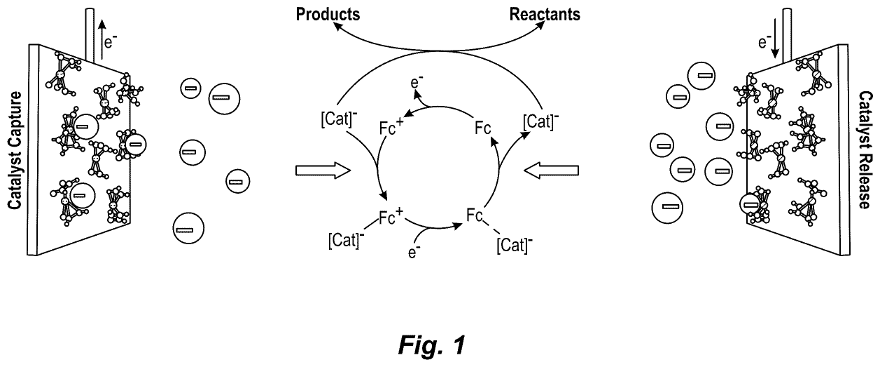

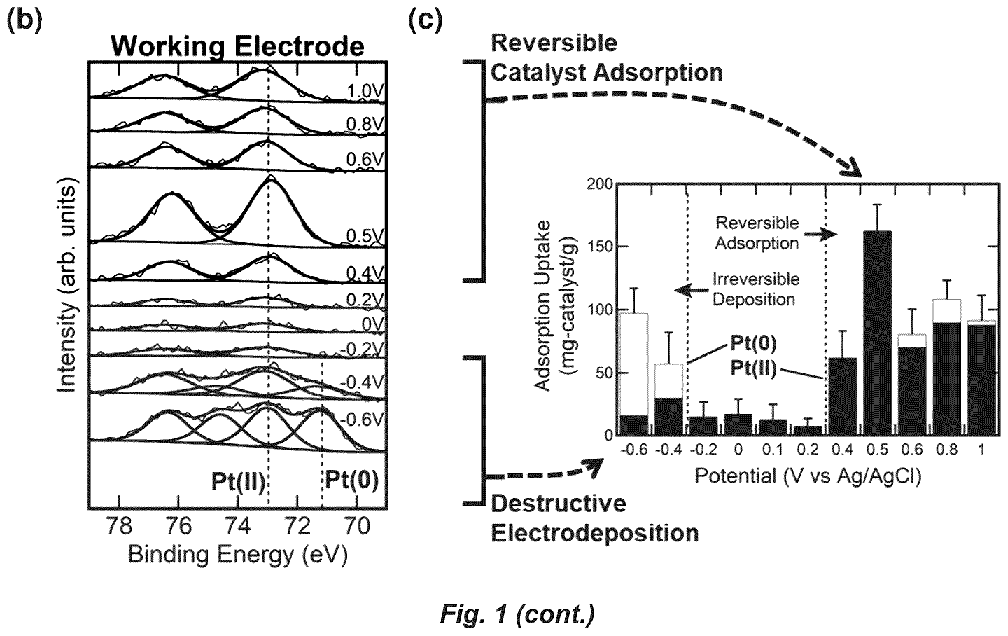

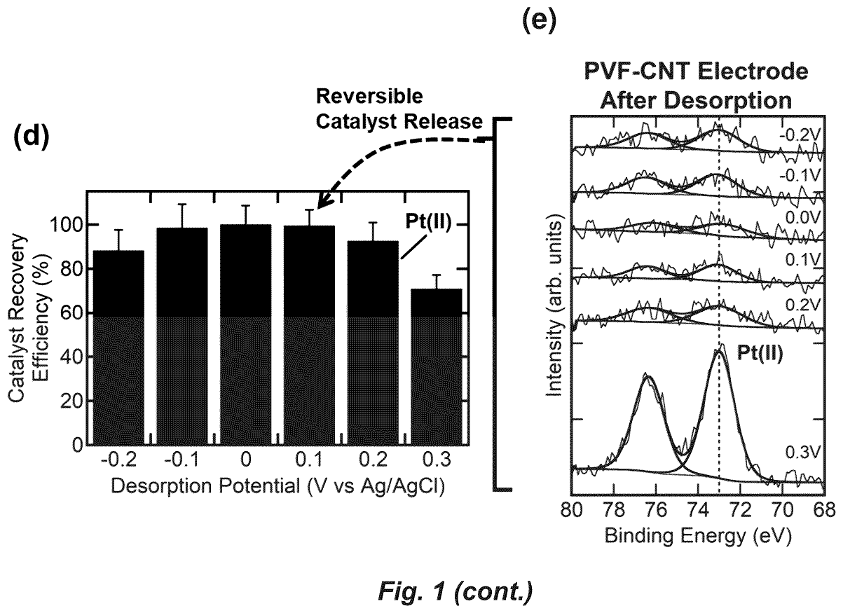

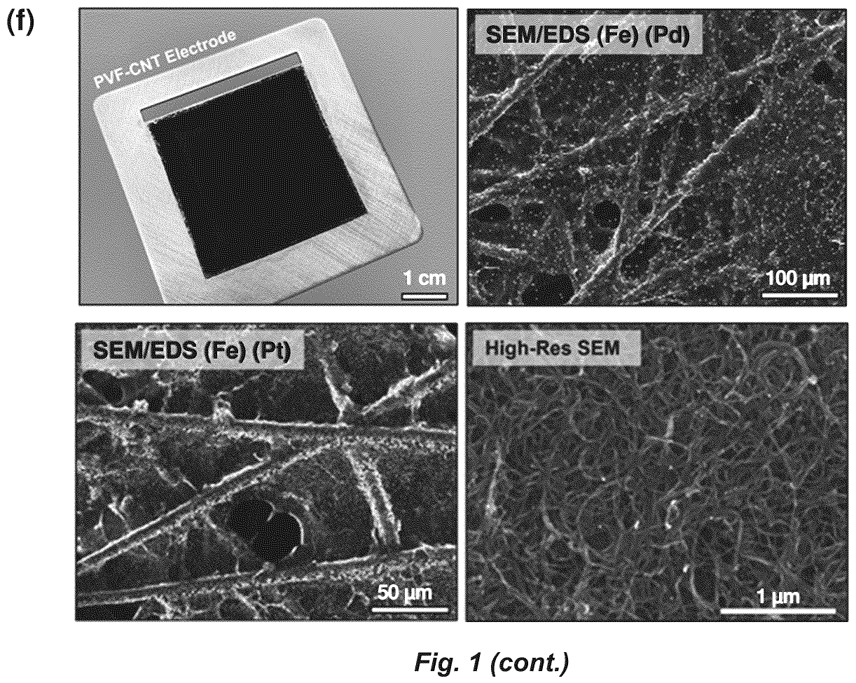

Polyvinyl ferrocene (PVF) coated electrode material was selected as the electrosorbent platform due to its rapid charge transfer kinetics and affinity for metal-containing anions. FIG. 1a depicts the proposed in-situ catalyst recovery scheme: post-reaction Pt or Pd-containing homogeneous catalyst from the product stream is captured by electrochemically oxidizing the redox-electrode, with the catalyst reversibly bound to oxidized ferrocenium sites on the surface while allowing reaction products to flow freely. The catalyst-laden electrode is transferred to a fresh reactant stream where the adsorbed catalyst is released via electrochemical reduction of ferrocenium to ferrocene, and the released catalyst begins a new reaction cycle. First, we investigate the electrochemically-driven sorption and interfacial interactions of platinum and palladium catalysts with the functional electrodes, then demonstrate feasibility of preserving the reactivity of important yet sensitive organometallic catalysts under a range of reaction conditions.

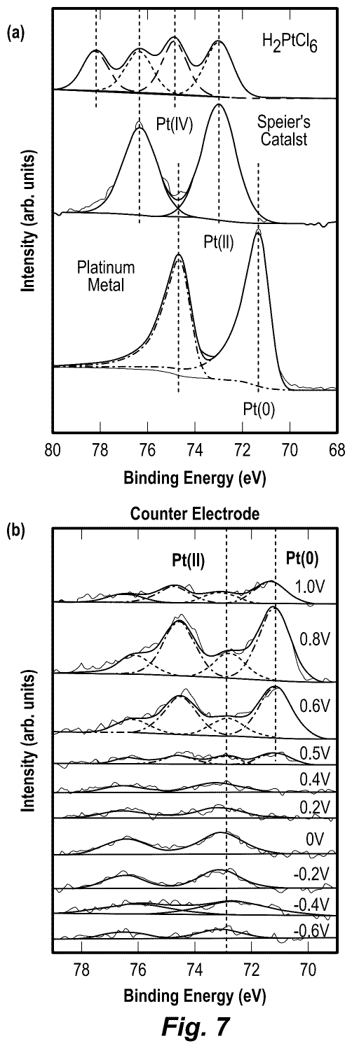

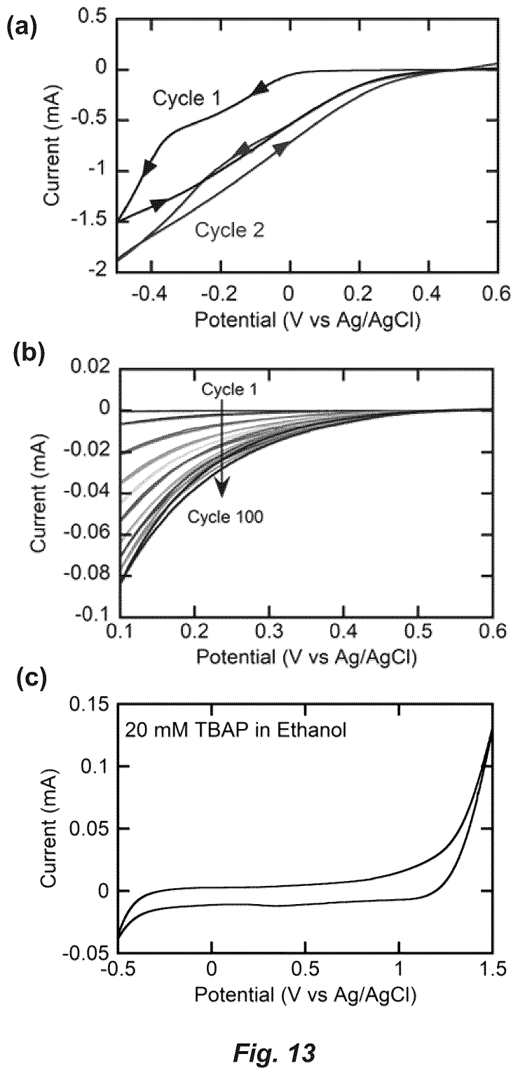

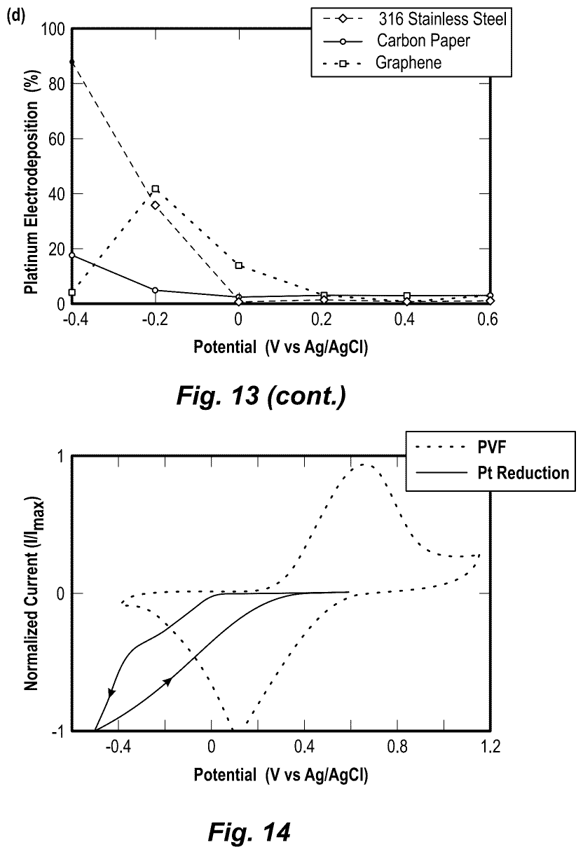

Platinum catalyst recycle. Electrochemical catalyst recycle was achieved with a 3-electrode electrochemical cell consisting of a PVF and carbon nanotube (PVF-CNT) coated working electrode, aa carbon paper counter electrode, and an Ag/AgCl reference. Toray 030 carbon paper was chosen as the current collector for both working and counter electrodes due to its superior performance at inhibiting electrodeposition of PGMs compared to other materials tested (316SS, Ti, graphene; FIG. 13d). Cyclic voltammogram of the PVF-CNT working and bare carbon paper counter cell (denoted PVF//CP) showed excellent reversible behavior and stability (FIG. 14). High resolution scanning electron microscopy (SEM) showed the nanoporous features of the PVF-CNT films, and EDS confirmed the presence of surface-bound iron (FIG. 1f). Electrosorption of the Pt catalysts was carried about by electrochemically oxidizing surface-bound Fc units to Fc⁺ to enable the selective binding of anionic platinum complexes. To distinguish between reversible redox-mediated electrosorption and destructive Faradaic electrodeposition of Pt, batch-scale experiments were performed at a range of chronoamperometric potentials (−0.6 V to 1.0 V vs Ag/AgCl). 1 mM of Speier's catalyst with 20 mM tetrabutylammonium perchlorate (TBAP) in ethanol was used as a model solution, and a constant potential was applied to the PVF//CP cell for 30 minutes for electrosorption. The catalyst uptake was measured for each potential using the difference in platinum concentration by ICP-OES before and after electrosorption. Additionally, XPS surface analysis of both working and counter electrode identified the oxidation state of captured platinum catalyst, where Pt4f spectra gave distinct doublet (delta=3.35 eV) peaks at 73 eV for Pt(II) and 71 eV for Pt(0) species (FIG. 7). The results (FIG. 1b and FIG. 1c) displayed three distinct regions of catalyst uptake: (1) E<−0.4 V in orange, (2) −0.2 V<E<+0.3 V in yellow, and (3) E>+0.4 V in blue.

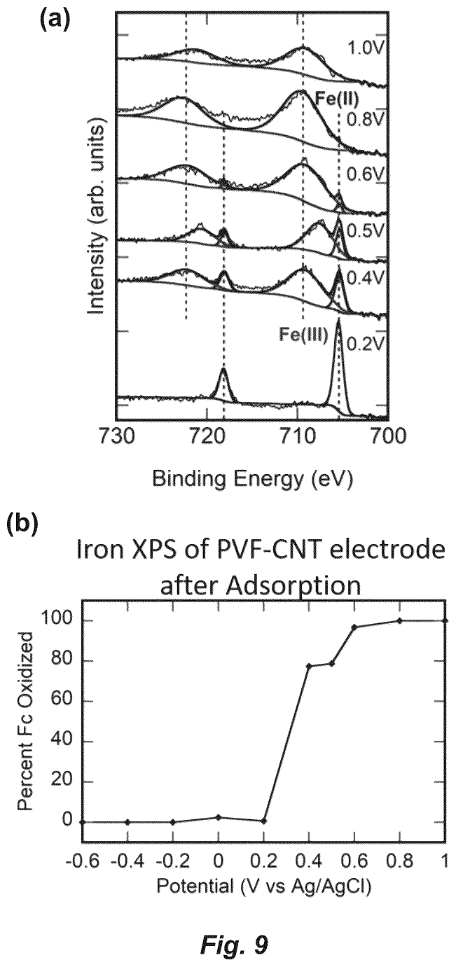

In the blue region of FIG. 1c (>+0.4 V), rapid Pt uptake was observed with a maximum at 0.5 V (162 mg/g). Oxidized ferrocene sites were observed on the working electrode with XPS at potential above 0.4 V, corresponding well with the oxidation potential of PVF from cyclic voltammetry (FIG. 9). Ptf4 spectra of the working electrode surface at >+0.4 V (FIG. 1b) showed 100% Pt(II), indicating PVF adsorption of Speier's catalyst without alteration of the platinum oxidation state. EDS mapping of the electrode after electrosorption at +0.5 V in FIG. 1f showed clear overlap of Fe-rich regions (from ferrocene) with Pt-rich regions (from Speier's catalyst). confirming ferrocene-mediated binding. In addition, TOF-SIMS surface analysis of PVF-CNT electrodes after adsorption at +0.5 V showed the presence of PtClₙ fragments, indicating that the electrosorbed Pt(II) species retained its chloride ligands. In the absence of a PVF-CNT coating, no Pt uptake was observed at potential above +0.4 V (FIG. 13d), therefore, we conclude that PVF coating was responsible for favorable Pt uptake above +0.4 V. Catalyst uptake was also observed in the orange region of FIGS. 1c (<−0.4 V) with a maximum at −0.6 V (98 mg/g). The region of catalyst uptake coincided with the region in which platinum electrodeposition occurred (FIG. 13a,d), which is also in agreement with literature. XPS analysis of the working electrode confirmed the reduction of Speier's catalyst to metallic Pt(0) (FIG. 1b), indicating that uptake at potentials more negative than −0.4 V can be fully attributed to irreversible platinum electrodeposition.

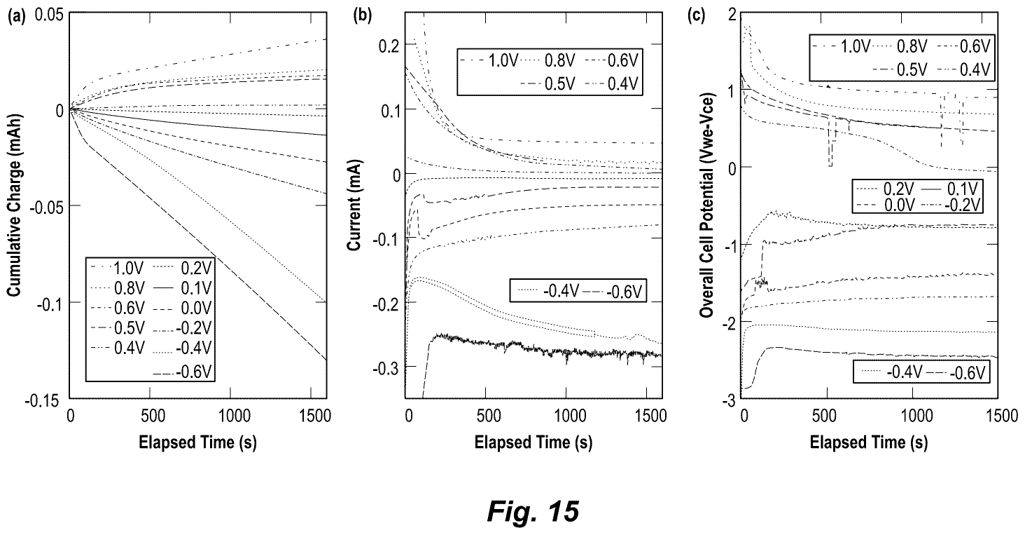

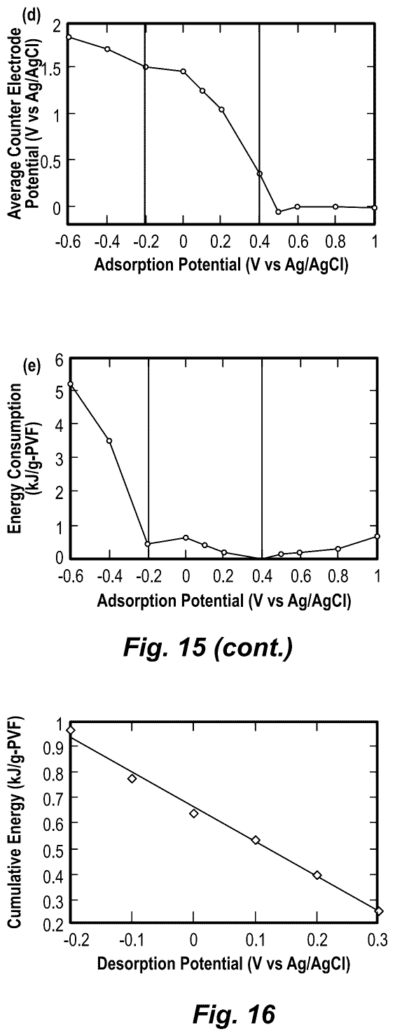

Platinum electrodeposition at −0.6 V was found to consume 610% more energy than electrosorption at +0.5 V (FIG. 15e). The energy savings of the electrosorption method were largely due to the high reversible uptake of Pt via selective binding towards PVF-CNT, vs the energy-intensive Faradaic process of electrodeposition, which often suffers high mass transfer overpotentials at low Pt concentrations. XPS analysis of the counter electrode at potentials higher than +0.6 V showed metallic platinum formation (FIG. 7b), indicating that high anodic potentials on the working PVF-CNT electrode can lead to favorable electrodeposition conditions at the counter electrode. Therefore, +0.5 V was chosen as the optimal adsorption potential due to its superior catalyst uptake (162 mg/g) without alteration of the platinum oxidation state of Speier's catalyst on either the working or counter electrode.

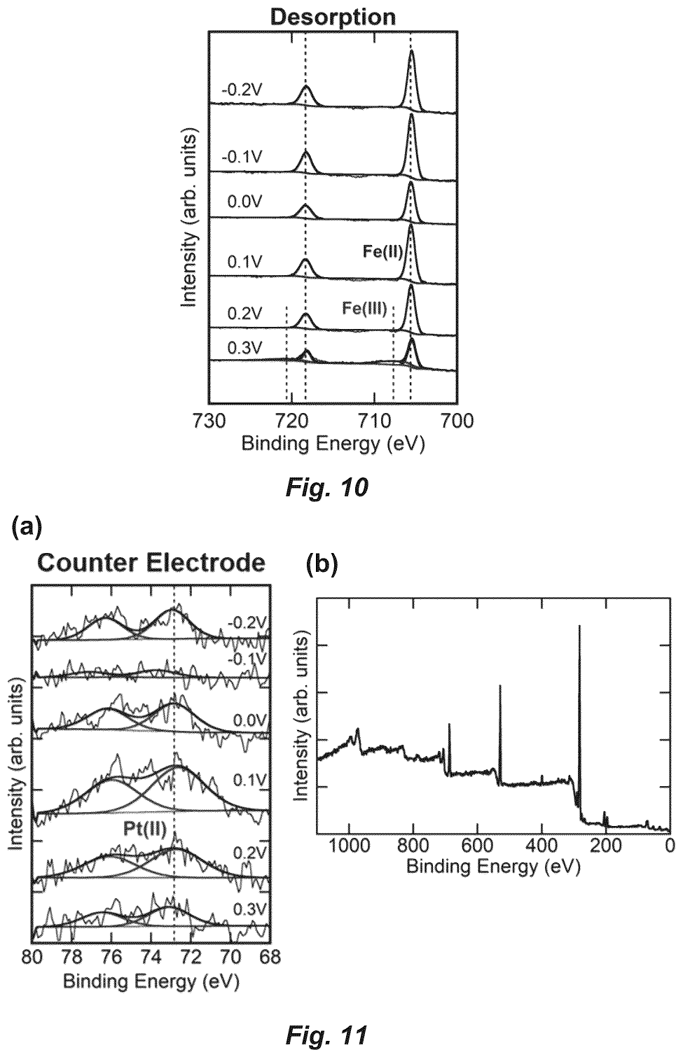

After catalyst adsorption at +0.5 V. Speier's catalyst was released from the redox-electrode into a Pt-free ethanol solution via an applied potential within the yellow region of FIG. 1c (−0.2 V<E<+0.3 V), where the applied potential was too high to electrodeposit Speier's catalyst (<−0.4 V) and low enough to reduce ferrocene(III) to ferrocenium(II) (<+0.4 V). A maximum recovery efficiency (defined as the mass Pt desorbed/adsorbed) of 99.5% was observed at +0.1 V (FIG. 1d), demonstrating excellent catalyst recyclability. XPS analysis of remaining platinum on the working (FIG. 1e) and counter (FIG. 11a) electrodes after desorption showed only Pt(II), indicating that no electroreduction of platinum catalyst occurred during release. XPS analysis of Fe on the working electrode (FIG. 10) after catalyst desorption showed complete reduction of Fe(III) to Fe(II) for all potentials up to +0.3 V. However, at +0.3 V, 40% of iron remained oxidized, corresponding to a lower recovery efficiency of 70.9%, and demonstrating that the mechanism of catalyst release correlates with reduction of Fe(III). Energy consumption for desorption expectedly increased with increasingly negative applied potential (FIG. 16). Therefore, an optimal desorption potential of +0.1V was chosen for all subsequent experiments due to its high Pt recovery efficiency (99.5%), and low energy consumption (0.53 kJ/g-PVF).

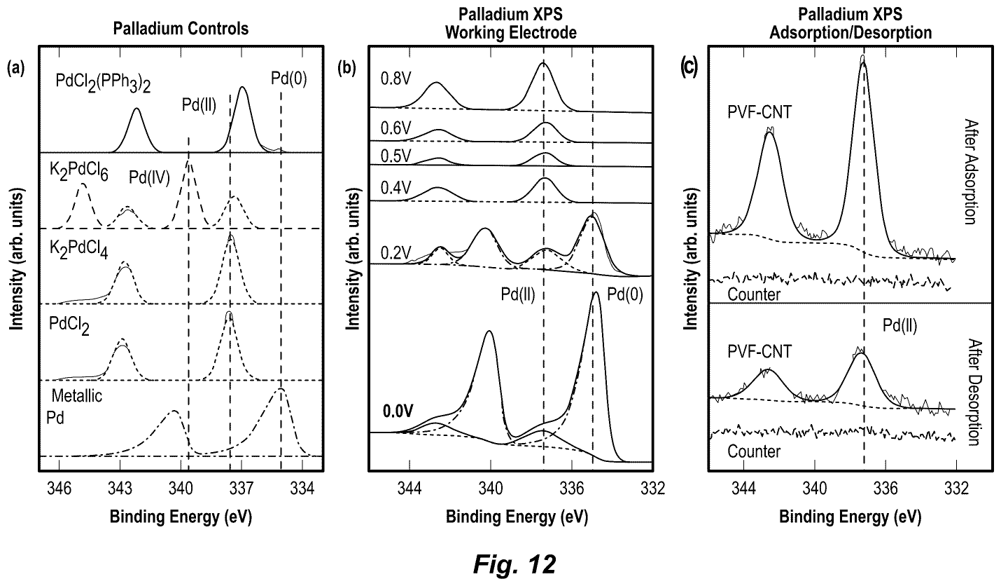

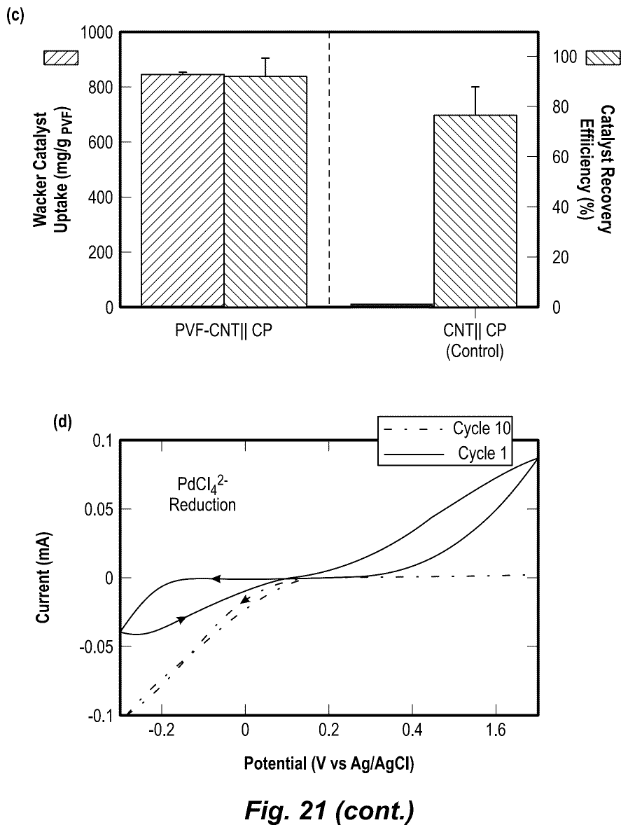

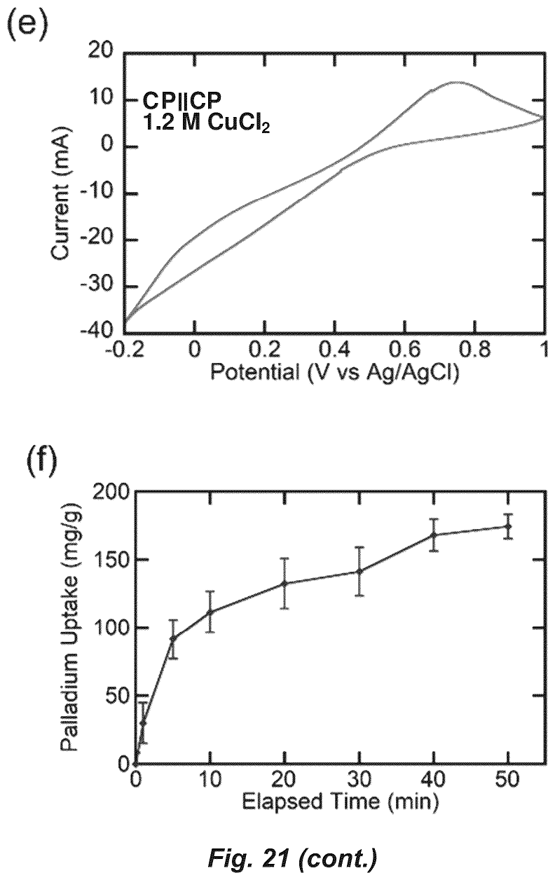

Palladium catalyst Recycle. Similarly, a series of batch scale experiments with the PVF//CP system with 1 mM palladium chloride in methanol with 20 mM copper(II) chloride as a model system for Wacker oxidation were tested at various chronoamperometric potentials (from 0.0 V to 1.0 V vs Ag/AgCl). Similar to the Pt electrosorption results, 3 distinct regions were observed in FIG. 21a for Pd electrosorption: PVF-mediated electrosorption region >0.4 V, Pd electrodeposition region <0.0 V, and region of safe desorption between 0.0V and 0.4V. Within the PVF electrosorption region (>0.4 V) we observed high Pd uptake (116 mg/g maxima at 0.8 V), and Pd XPS spectra (FIG. 12b) of electrodes showed that the Pd(II) oxidation state was unaltered. PVF-free adsorption at 0.6V (FIG. 21b) showed no appreciable palladium uptake, confirming the redox-mediated mechanism for palladium catalyst recovery at potentials above 0.4 V using PVF-CNT. At an applied potential below 0.2 V. Pd uptake was again observed (111 mg/g maxima at 0.0 V) where palladium electrodeposition was observed to occur (FIG. 21d), with Pd(0) observed on the working electrode <0.0 V. Following PVF electrosorption at 0.6 V, recovery of captured palladium catalyst was possible electrochemically via release through an applied potential of 0.1 V with a recovery efficiency of 92%, and no sign of palladium was observed with XPS analysis on the fully regenerated electrode (FIG. 12c).

### Recycling and Re-Use of Homogeneous Silane Etherification Catalyst

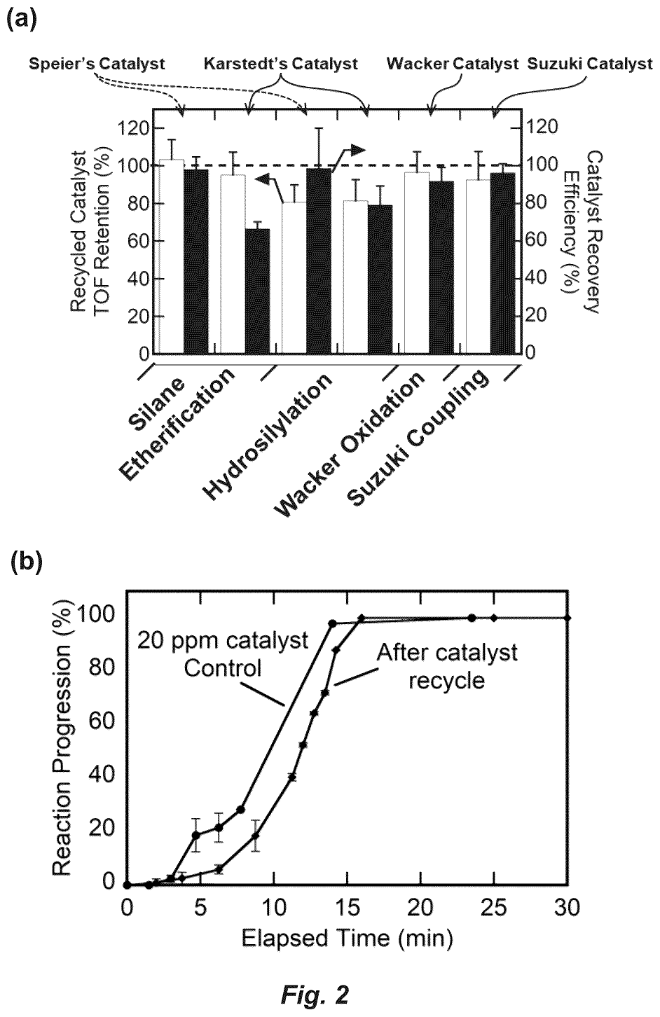

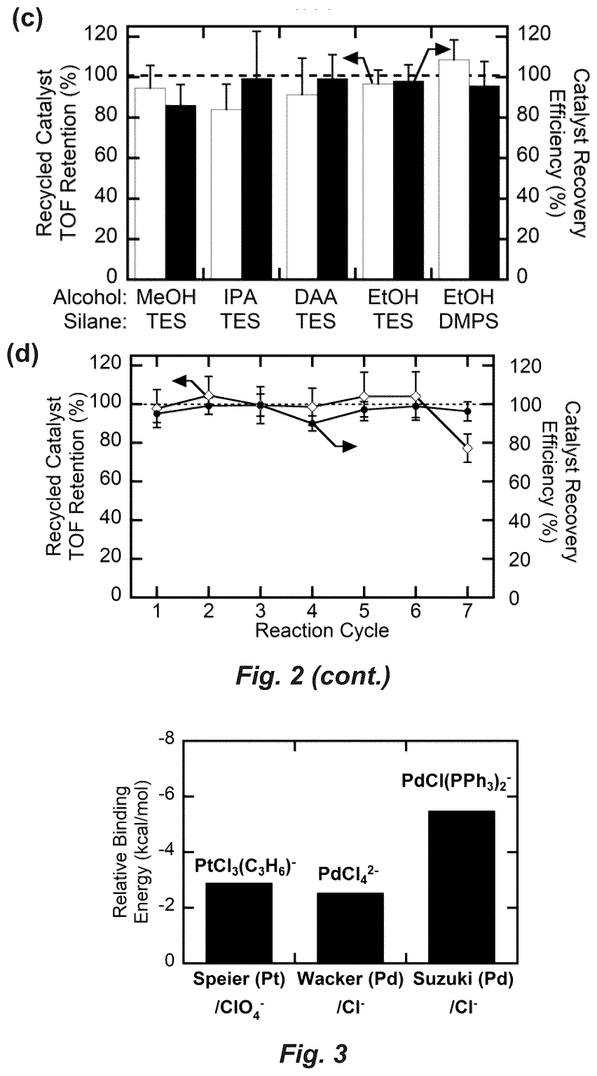

Speier's catalyst recycling experiments were carried out by first adsorbing catalyst from the product solution of a control triethylsilane (TES) etherification with ethanol reaction containing 50 ppm Speier's catalyst. PVF-CNT electrosorption was carried out via chronoamperometry at +0.5 V for 30 minutes from the product solution, and an average uptake of 112 mg Pt/g-PVF was observed. The catalyst laden electrode was then transferred to a solution of fresh reactants, where catalyst was electrochemically released in-situ to initiate a new reaction cycle. Desorption via chronoamperometry at +0.1 V for 30 minutes showed a 99.5% catalyst recovery efficiency (FIG. 2a). ESI-MS, ¹H-NMR, and LC-MS analysis confirmed the desorbed catalyst solution (referred to as the recycled reaction) successfully reacted to form triethylethoxysilane with 100% conversion and an average turnover frequency of 1247 min⁻¹, indicating that catalyst activity was indeed retained after recycling.

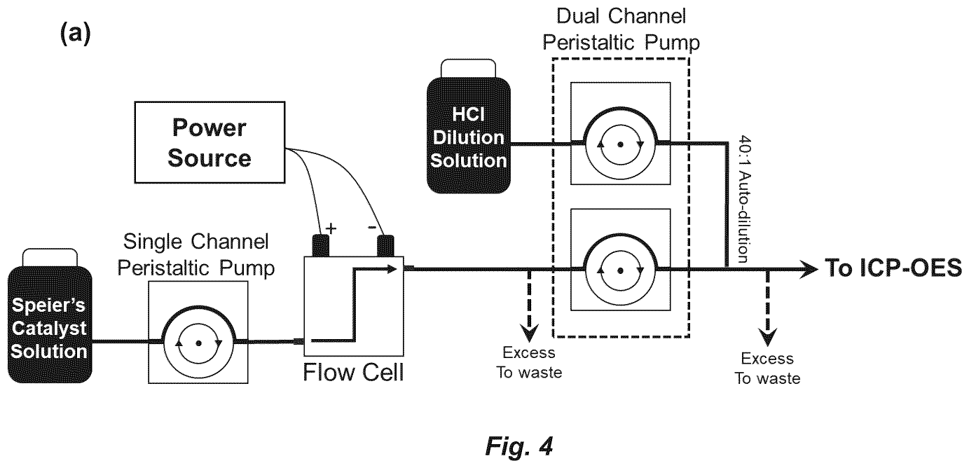

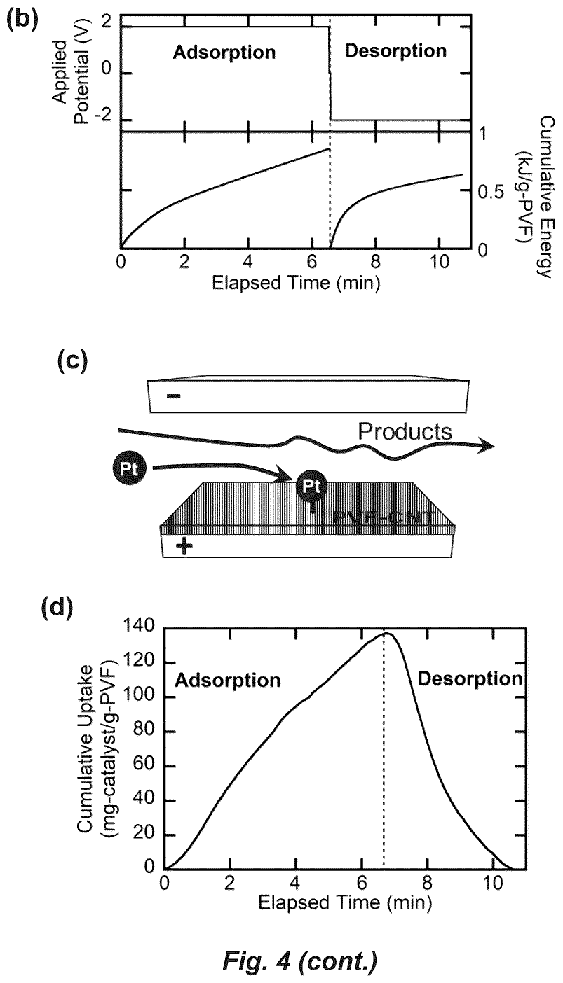

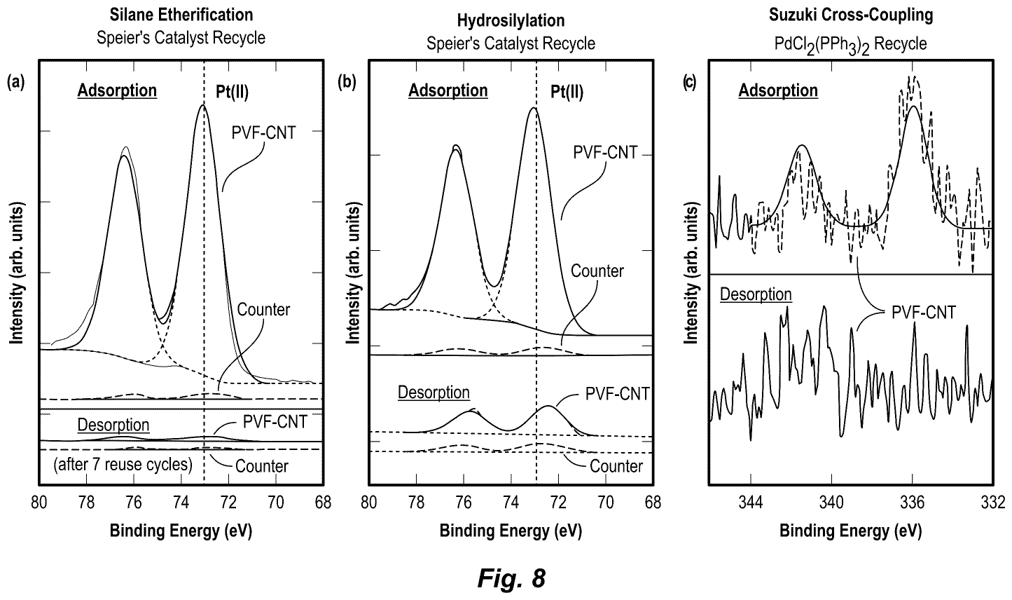

The kinetics of the recycled reaction were compared to a control reaction, catalyzed with 20 ppm of fresh Speier's catalyst. The two reactions showed agreement in reaction progress and rates, and 96±6% of the catalyst activity was retained after recycling: TOF of 1325 min⁻¹ with recycled catalyst and 1278 min⁻¹ with fresh Speier's catalyst (FIG. 2b). The product was isolated and confirmed with ¹H-NMR, ESI-MS, and GC-MS, and the recycled catalyst reaction retained 92% of the isolated product yield compared to unrecycled control reaction (Table 1). For both the recycled and fresh catalyst reactions, a lag period was observed in the first 5 minutes followed by rapid progression to 100% conversion of TES within 15 minutes. Complete catalyst release was observed to require roughly 4 minutes when recycled (FIG. 4d). The initial lag period of the recycled reaction compared to the control is due to the gradual in-situ release of the catalyst from the electrode. TOF-SIMS analysis of the PVF-CNT electrode surface after catalyst adsorption showed PtClₙ fragments indicating the presence of chloride ligands bound to the adsorbed platinum catalyst, whereas TOF-SIMS analysis of the electrode surface following catalyst desorption showed no presence of platinum. XPS analysis of electrodes confirmed that Pt(II) was only found on the PVF-CNT electrode after adsorption (FIG. 8a).

TABLE 1
Reaction summary for control reactions with fresh catalyst
and electrochemically recycled catalyst reactions.

| | | Catalyst | | Reaction | Turnover | Turnover | Isolated |
|---|---|---|---|---|---|---|---|
| | | Concentration | Conversion | Time | Number | Frequency | Yield |
| Reaction | Type | (ppm) | (%) | (hr) | (—) | (1/hr) | (%) |
| Silane | Control | 52.21 | 97.5 | 0.083 | 5490 | 65884 | 38 |
| Etherification | recycle | 9.27 | 97.3 | 0.5 | 30859 | 61718 | 35 |
| Hydrosilylation | control | 103.2 | 97.3 | 4 | 2772 | 693 | 81 |
| | recycle | 25 | 66.2 | 12 | 7785 | 649 | 67 |
| Wacker | control | 1998 | 100 | 8 | 49 | 6.13 | 41 |
| Oxidation | recycle | 365 | 100 | 24 | 145 | 6.05 | 40 |
| Suzuki | control | 17.18 | 62.5 | 8 | 964 | 121 | 61 |
| Coupling | recycle | 4.82 | 51.6 | 24 | 2837 | 118 | 67 |

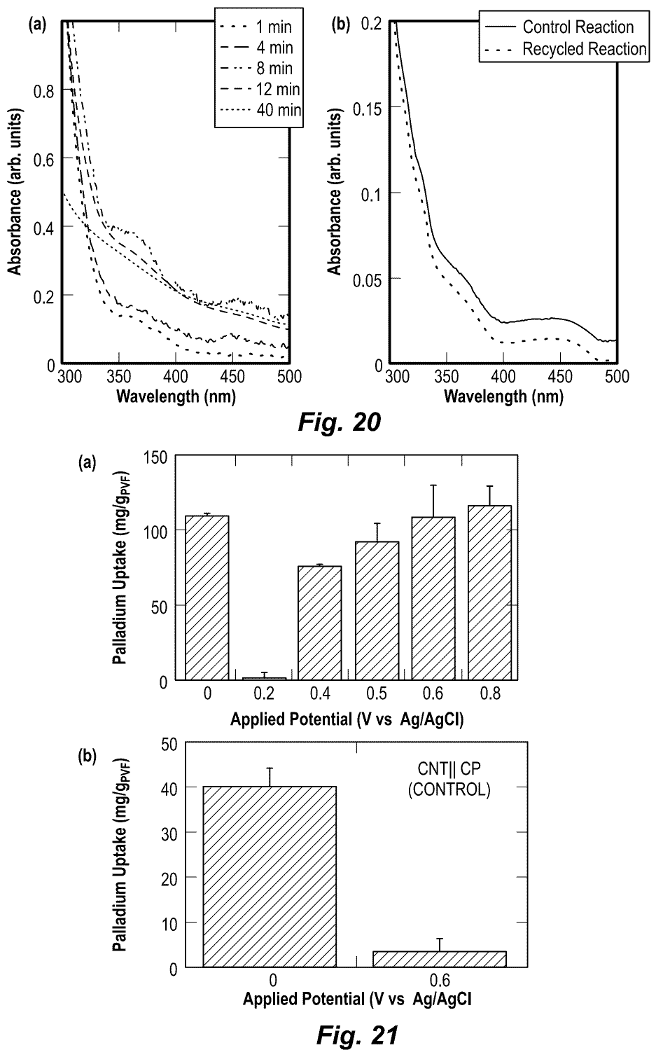

To confirm that catalyst recycling was indeed caused by the release of catalyst from PVF-CNT electrodes, a PVF-free control experiment was conducted, yielding reaction progress with less than 5% yield of triethyethoxysilane for the recycled reaction. To verify that Speier's catalyst was the only reaction pathway, PVF-CNT electrodes were oxidized in a solution devoid of the homogeneous catalyst, and subsequently reduced in silane etherification reactants (to mimic the recycling process); the result showed no evidence of reaction. The active platinum catalyst was detected with UV spectroscopy in situ during electrochemical release of Speier's catalyst into silane etherification reactants (FIG. 20). The UV spectra of a control silane etherification reaction (where 50 ppm of fresh Speier's catalyst was used) showed a distinct peak at 360 nm, assigned to the active catalytic platinum species in accordance with literature. Comparing recycled catalyst reaction spectra to control, features corresponding to the active catalyst were preserved, thus indicating that reversible capture and release did not affect catalyst structure or activity, allowing for immediate reuse.

The electrochemical recycling of Speier's catalyst was carried out for a range of alcohol and silane substrates for silane etherification (FIG. 2c). For the entire substrate scope, 95% of the catalyst activity was retained after recycling. Catalyst uptake varied from 52.3 mg/g with isopropanol-TES to 151.1 mg/g with ethanol-dimethylphenylsilane. Recovery efficiency of the PVF-CNT electrode was consistently high, averaging 97.7% of all adsorbed catalyst released, thus demonstrating the generality of the recycling approach for diverse silane etherification reactions.

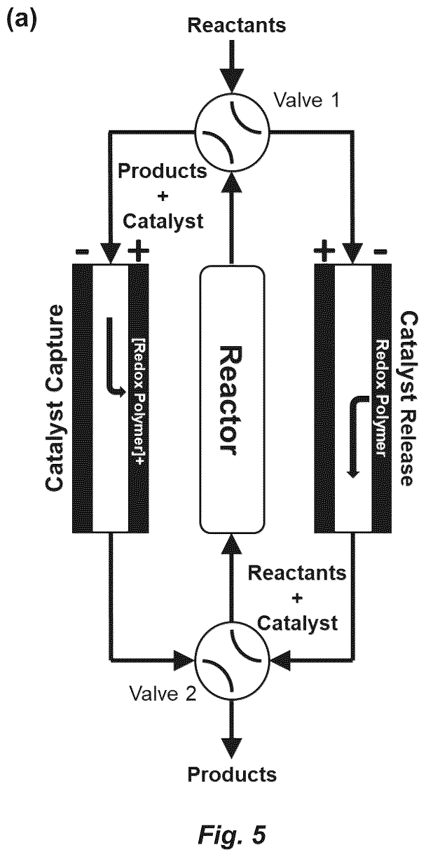

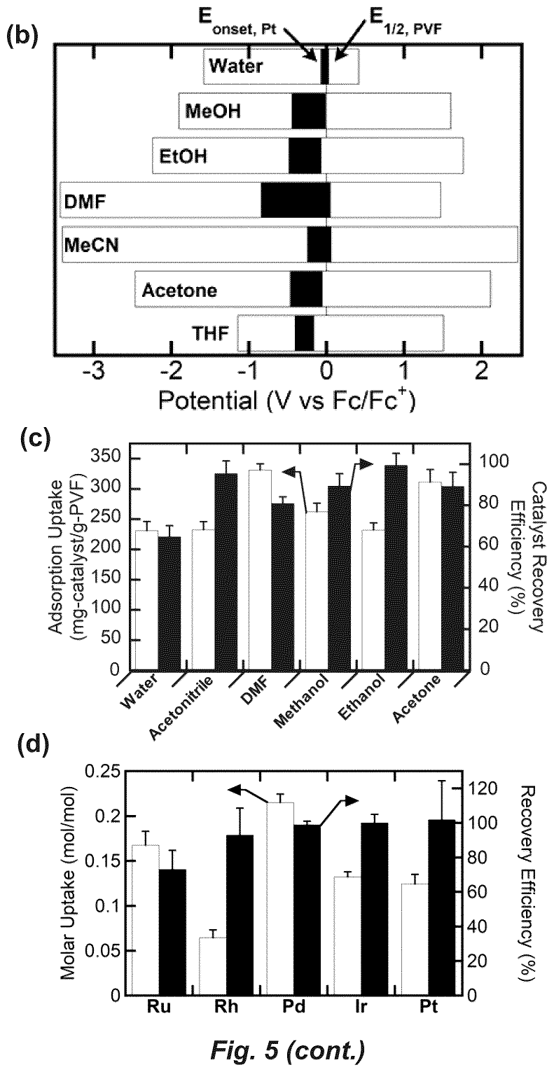

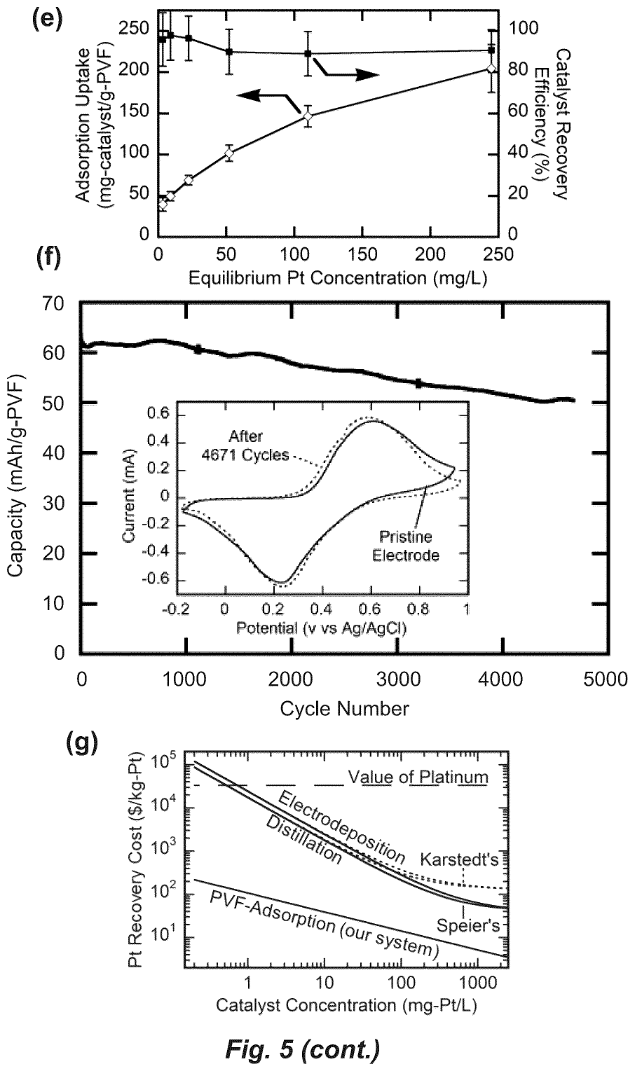

Electrode Cycling. To confirm electrode cyclability, a PVF-CNT electrode was reused for multiple catalyst recovery cycles (FIG. 2d) in the etherification reaction of TES with ethanol. Each catalyst cycle consisted of a 20-minute adsorption at 0.5 V, a 20-minute desorption at 0.1 V, and a 30-minute period for the recycled reaction to progress. Speier's catalyst uptake and regeneration remained consistent throughout all cycles, with an average uptake of 100 mg/g and a regeneration efficiency of 99.7% for 7 consecutive cycles of recycling. The recycled catalyst turnover frequency and product yield remained consistent relative to the corresponding control reaction, with an average turnover frequency of 1354 min⁻¹, corresponding to a 95±6% retention of catalyst activity upon release. Additionally, no Pt(II) or Pt(0) was observed with XPS analysis on reused electrodes after recycling (FIG. 8a), confirming elimination of irreversible electrodeposition, and avoidance of catalyst degradation. Finally, PVF-CNT electrodes were cycled over 5000 charge/discharge cycles (methodology described in SI), and cyclic voltammograms taken before and after electrode cycling show no loss in electrochemical performance (FIG. 5f), supporting the robust longevity of these electrodes in relevant organic solvents.

### Recycling and Re-Use of Homogeneous Pt-catalysts for Hydrosilylation

Speier's catalyst. As a proof of concept, we applied our catalyst recycling system to the hydrosilylation of TES and phenylacetylene (PhA), using 100 ppm Speier's catalyst. After an applied potential of +0.5 V, PVF-CNT electrodes removed catalyst from the reaction mixture with an uptake of 135 mg/g, and electrode-bound platinum was released into reactants following a reducing potential of +0.1 V with a 98.0% recovery efficiency (FIG. 3). A selectivity factor of 5.5 Speier's catalyst vs perchlorate was estimated from XPS after hydrosilylation recycle indicating preferential ferrocene binding (FIG. 11b). The recycled reaction was analyzed with ¹H-NMR, ESI-MS, and CG-MS, and the recycled catalyst was found to retain 81±10% of its catalytic activity (830 min⁻¹ TOF). Additionally, the isolated product yield for the recycled reaction was 83% of control (Table 1). No Pt(0) was observed on either electrode after adsorption and desorption (FIG. 8b), and TOF-SIMS analysis of the PVF-CNT electrode surface after electrosorption showed PtClₙ fragmentation, indicating the retention of chloride ligands on adsorbed platinum catalyst.

Karstedt's Catalyst. Electrochemical recycle of Karstedt's catalyst was studied in a hydrosilylation model reaction of TES and phenylacetylene. Karstedt's catalyst was electrosorbed from a product solution with an uptake of 279 mg/g (FIG. 3). The presence of Pt on the electrode surface was confirmed with TOF-SIMS analysis. EDS analysis of PVF electrodes after adsorption showed a selectivity factor of 3.36 for Karstedt's catalyst over competing perchlorate anions, with a clear accumulation of Pt on Fe adsorption sites. The catalyst was released into reactants via reduction of the PVF, and 221 mg/g of Pt was released resulting in a recovery efficiency of 79.2%. The recycled reaction yielded a turnover frequency of 583 min⁻¹, indicating that 90% of Karstedt's catalyst activity was retained after recycle. Using a similar procedure, Karstedt's catalyst was also recycled for TES-ethanol silane etherification with similar performance: 267 mg/g uptake, 67% recovery efficiency, and 96% retention of catalyst activity after recycling (FIG. 3).

Electric conductivity was measured for solutions of the silane etherification reactions catalyzed by a range of concentrations of Karstedt's catalyst (from 0 mM Pt to 1.3 mM Pt in the presence of reaction substrates) and compared to control solutions of the catalyst in pure ethanol (no reactants). Once Karstedt's catalyst was added, the reaction progressed, and the solution resistance drastically reduced from 3.5 MΩ to 62 kΩ (FIG. 19). On the other hand, the addition of Karstedt's catalyst to pure ethanol showed little to no change in solution resistance. The molar conductivity of Karstedt's catalyst was two orders of magnitude higher in the silane etherification reaction solution (12.6 μScm⁻¹ mM⁻¹) than the catalyst solely in pure ethanol (0.07 μScm⁻¹ mM⁻¹). These observations, in addition to the catalyst recycling results, provide evidence that ionic catalytic intermediates are formed following silane etherification, strongly indicating that an anionic catalyst intermediate is likely to be the binding species during separations despite a neutral starting pre-catalyst. These results are in line with observations by Stein et al., which suggests that platinum converges to a common active catalytic intermediate regardless of initial precatalytic composition. Our results indicate that an anionic intermediate plays a key role in both the Speier and the Karstedt's cycle.

### Recycling and Re-Use of Homogeneous Pd-Catalysts for Oxidation and Cross-Coupling

Wacker Oxidation. The Wacker reaction catalyst recycle of 60 mM PdCl₂ was carried out by electrochemical adsorption (0.6 V for 30 minutes), yielding an average uptake of 989 mg-Pd/g-PVF (FIG. 21c). Catalyst release was conducted in fresh reactant solution via an applied potential of 0.2 V for 30 minutes, yielded a recovery efficiency of 84%. A control adsorption using CNTs resulted in only 12 mg/g of the Pd catalyst, proving catalyst recycle depended on PVF. From GC-MS, the electrochemically recycled palladium catalyst retained 93% of its catalytic activity (TOF of 0.54 hr⁻¹), demonstrating that efficient recycle of anionic palladium complex catalyst was possible with the electrosorption system while retaining full catalytic activity for Wacker-like oxidation. Lastly, the product was isolated and confirmed with ¹H-NMR and ESI-MS, and the recycled catalyst reaction retained 98% of the isolated product yield compared to unrecycled control reaction (Table 1).

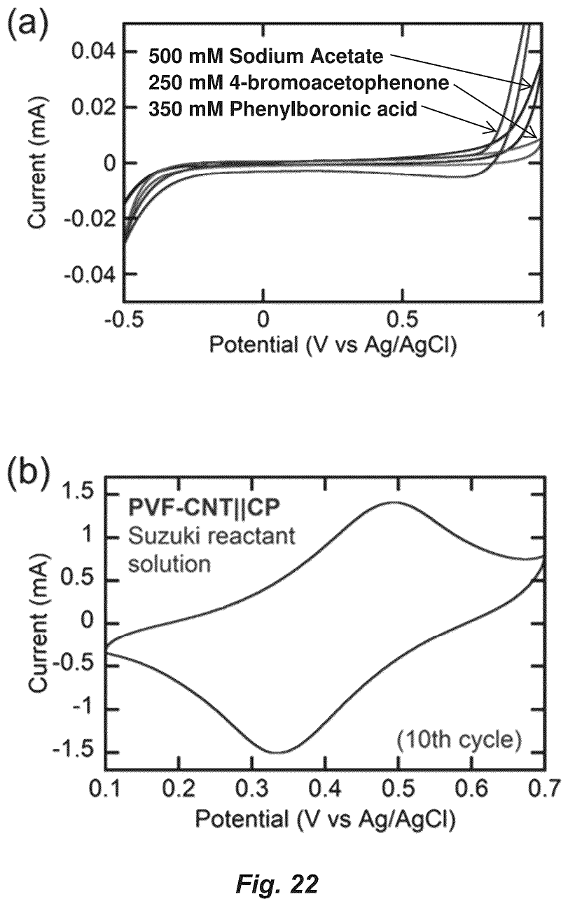

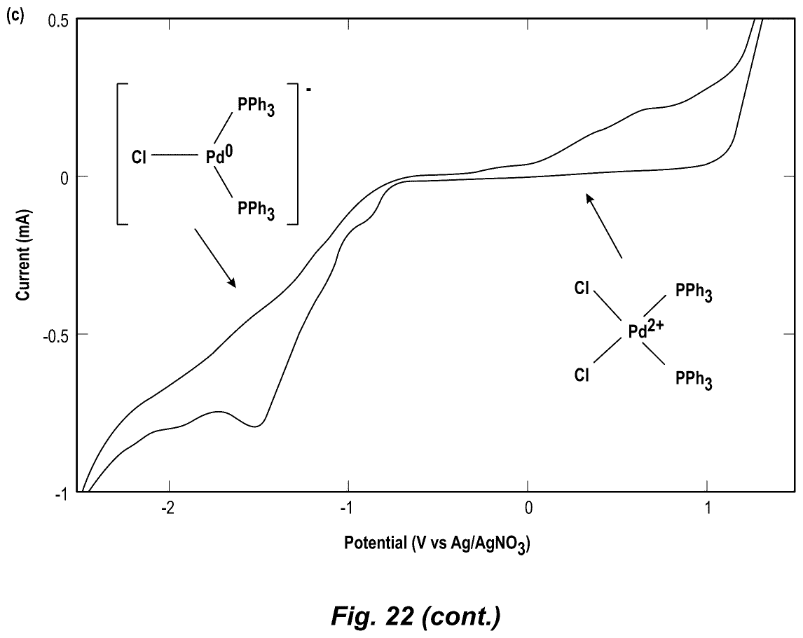

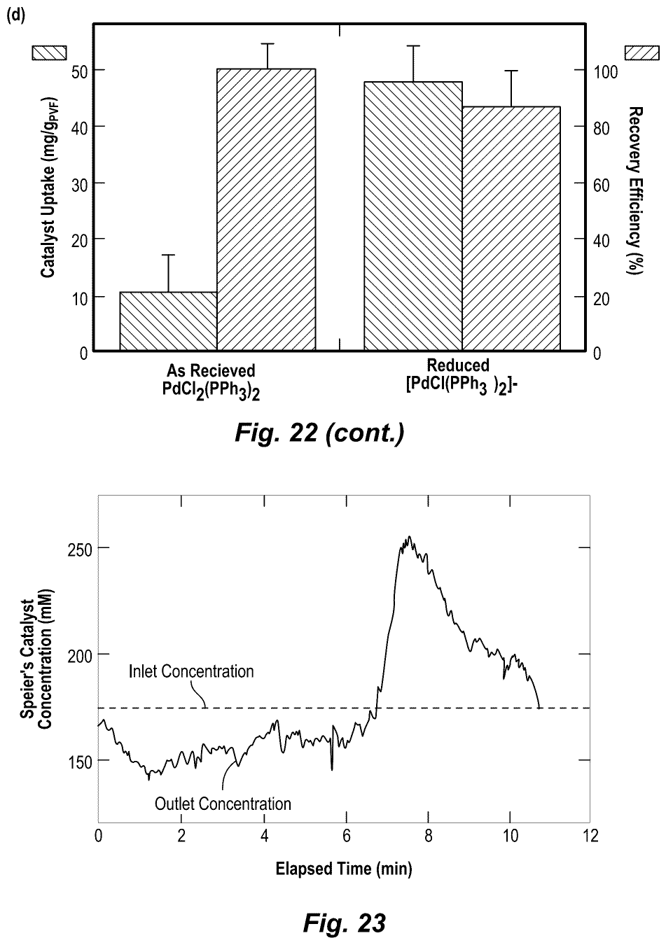

Suzuki Cross-Coupling. In Suzuki cross coupling, the pre-catalyst, PdCl₂(PPh₃)₂ is reduced to an anionic Pd(0) form, retaining its triphenylphosphine ligands (FIG. 22c), with the anionic [PdCl(PPh₃)₂]⁻ species acknowledged as the active intermediate species in the catalytic cycle. To investigate the specific recovery of this charged intermediate, electrosorption was conducted with an isolated solution of the anionic active catalyst (1 mM [PdCl(PPh₃)₂]⁻) in THE, and an uptake of 47.5 mg/g with a recovery efficiency of 86.4% was achieved. The anionic [PdCl(PPh₃)₂]⁻ complex showed a 78% increase in uptake compared to the neutral PdCl₂(PPh₃)₂ species (10.6 mg/g; FIG. 22d), illustrating selectivity of ferrocenium binding with the anionic catalyst intermediate in Suzuki-type reactions.

Recycling of Suzuki catalyst by PVF-CNT was accomplished with electrosorption from a product solution containing 18 ppm Pd catalyst at 0.6 V for 30 minutes (uptake of 11.3 mg-Pd/g- PVF). The recovered catalyst was released directly into a new reactant solution via an applied potential of 0.2 V for 30 minutes, yielding a recovery efficiency of 96.2%. Following desorption, the reactant solution with recycled catalyst was allowed to progress for 24 hours. From GC-MS, the electrochemically recycled palladium catalyst retained 100% of its catalytic activity (TOF of 183 hr⁻¹), indicating proof-of-principle of homogeneous recycling. Additionally, the product was isolated and confirmed with ¹H-NMR and ESI-MS, and the recycled catalyst reaction retained 100% of the isolated product yield compared to unrecycled control reaction (Table 1). An atomic ratio of 2.5:1 (+0.4) phosphorous to palladium was observed in the recycled reaction solution with ICP-OES, indicating that the electrosorbents successfully recovered the palladium catalyst with its accompanying triphenylphosphine ligands. Additionally, no palladium was observed with XPS on the PVF-CNT or counter electrode after release (FIG. 12c), confirming complete catalyst release with no palladium electrodeposition.

### Mechanistic Investigation of Catalyst Binding via Electronic Structure Calculations

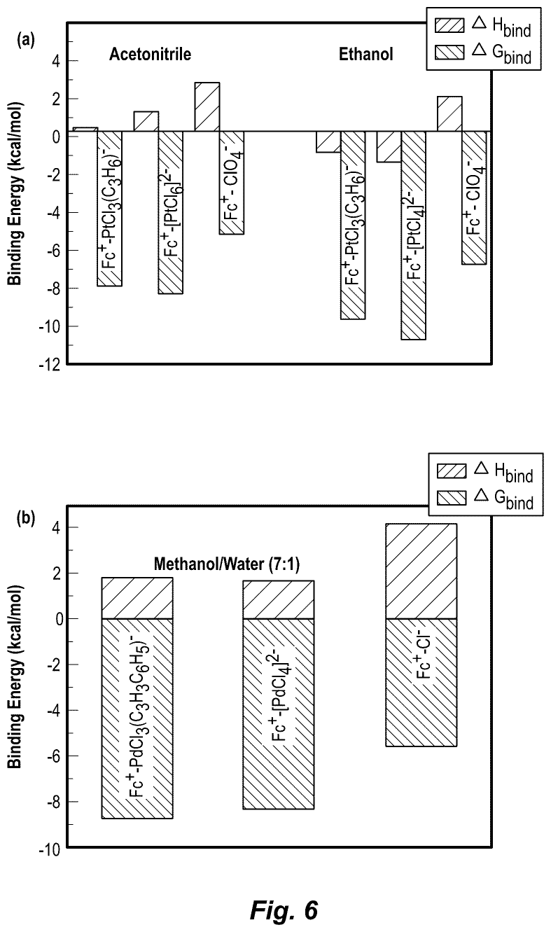

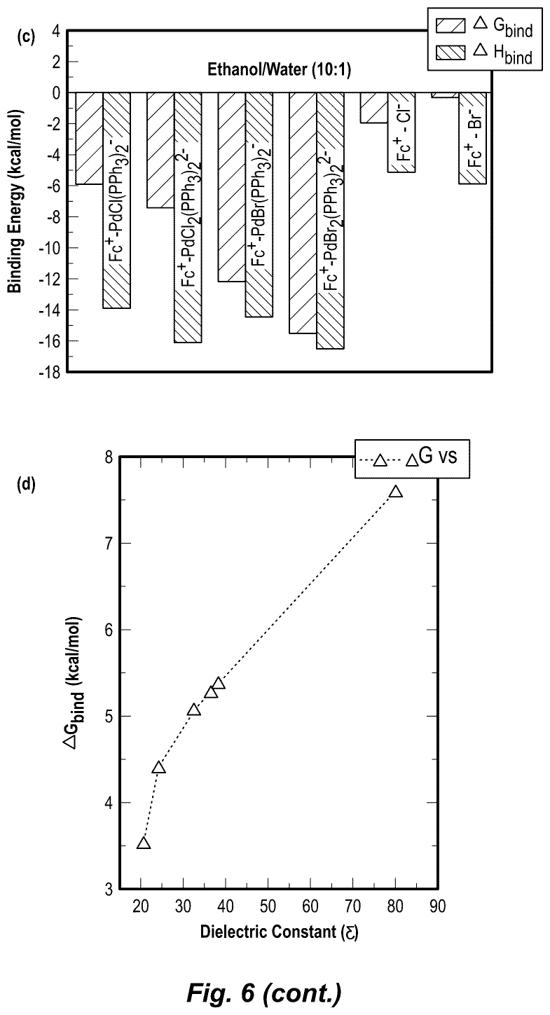

To obtain atomistic insights into the experimentally observed separation trends, we carried out density functional theory (DFT) and domain-based local pair natural orbital coupled-cluster theory (DLPNO-CCSD (T)) calculations to corroborate separation trends and characterize the binding mechanism of ferrocenium cation (Fc⁺) interacting with Speier's catalyst ([PtCl₃(CH₂CHCH₃)]⁻), Wacker catalyst ([PdCl₄]²), Suzuki coupling catalyst ([PdCl₂(PPh₃)₂]²⁻), and relevant competing ions (Cl⁻, ClO₄⁻). The Pt-and Pd-complexes in Speier's and Wacker catalysts interact with the cyclopentadiene ring of Fc+through C—H . . . Cl close contacts (2.6-3.1 Å distance; For Suzuki coupling, Fc⁺ interacts with [PdCl₂(PPh₃)₂]²⁻ and [PdCl(PPh₃)₂]⁻ through non-covalent bond formation with Pd(0) with a C—H . . . Pd distance around 2.6 Å. Both Suzuki coupling complexes also exhibit the stabilizing C—H . . . π interaction between cyclopentadiene and phenyl rings at 2.5-2.6 Å distance. The binding affinity trend (FIG. 3 and FIG. 6) reveals preferential sorption of catalysts over spectator anions for all catalytic systems considered, in agreement with experiments. Speier's catalyst in ethanol interacts more strongly with Fc⁺ than perchlorate, with the binding affinity trend [PtCl₃(C₃H₆)]⁻≈[PtCl₆]²⁻>[ClO₄]⁻. Polarizable solvents with a higher dielectric constant (such as acetonitrile) solvates individual ions more strongly, destabilizing the ionic pair adducts and disfavoring sorption (FIG. 6a). Similarly, Wacker catalyst is adsorbed preferentially over Cl⁻, and the binding affinity presents an order of [PdCl₃(CH₂CHC₆H₅)]⁻>[PdCl(PPh₃)₂]⁻>Cl⁻. For Suzuki coupling catalysts, the binding affinity decreases as [PdCl(PPh₃)₂]⁻>[PdCl₂(PPh₃)₂]²⁻>Cl⁻. Adsorption of bromide-substituted Suzuki coupling catalysts is more pronounced than their chloride counterparts, likely due to smaller Cl⁻ size and thus higher surface charge density that promotes ion solvation and destabilizes adducts. In sum, the results indicate the stronger binding of the catalyst active complexes to ferrocenium over competing inorganic salts from solution, in alignment with the experimental results presented.

A local energy decomposition analysis was performed to understand the contribution of different factors (electrostatic, exchange, dispersion, and charge transfer) to the interaction between Fc⁺ and catalysts/competitive ions. While electrostatics dominate the overall interaction energy, solvation of catalysts and Fc⁺ in polar solvents reduces electrostatic interactions upon adduct formation. According to our experiments, charge transfer occurs predominantly from anions to ferrocenium cation, i.e., from HOMO of catalysts/anions to LUMO of Fc⁺, playing a role in dictating selectivity. The results show that dispersion interactions are more prevalent in Pt/Pd complex systems, as compared to competitive anions due to the presence of more than two C—H . . . Cl close contacts in these systems. Dispersion energy maps indicated the atom pairs involved in dispersion interactions between Fc⁺ and anions.

### Redox Electrosorption Versatility Towards Solvent, Electrolyte, and Noble Metal Catalyst

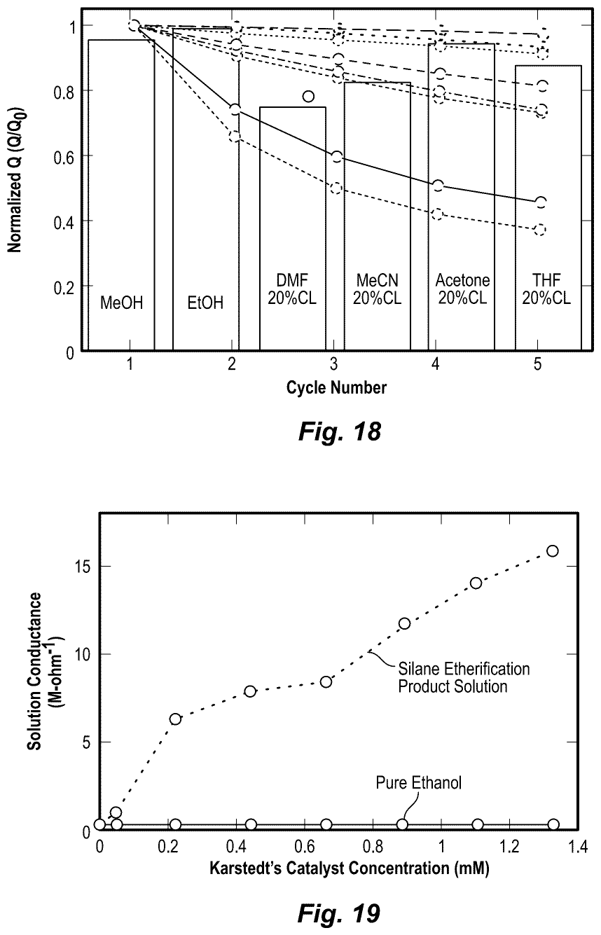

Solvent selection. Recycle performance of the PVF//CP system was tested in relevant industrial solvents, covering range of dielectric values: dimethylformamide, acetonitrile, methanol, acetone, tetrahydrofuran, water, and ethanol. Successful recycle of Speier's catalyst was possible for all solvents with an average uptake of 266±44 mg/g-PVF and recovery efficiency of 87±12% (FIG. 5b). The solvent stability window, redox potential of PVF, and the reduction potential of Speier's catalyst were determined for each system to evaluate the impact of solvent choice. FIG. 5a shows a blue region where PVF can oxidize and a yellow region represents where PVF can safely reduce, without side reactions. The orange region indicates a region where Speier's catalyst will electrodeposit. The lowest catalyst recovery efficiency of 68% was obtained in water, where the highest electrodeposition potential was observed. For each solvent, the solubility/stability of PVF was determined by measuring faradaic capacity over several cycles using CVs (FIG. 18). Protic solvents such as ethanol and methanol showed virtually no loss of capacity. While some capacity loss was apparent in DMF, acetonitrile, acetone, and THE, crosslinking of the PVF-CNT enhanced electrode stability by 87% on average. Our study demonstrates the wide compatibility of the redox-electrode platform with different solvent systems.

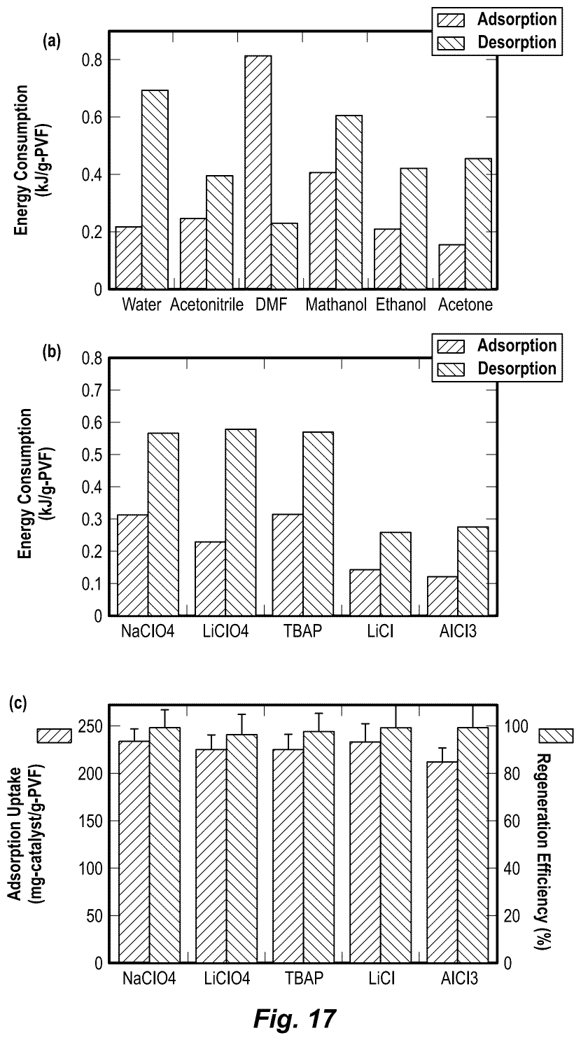

Electrolyte selection. Recovery of Speier's catalyst was found remarkably insensitive to the identity of the electrolyte species, showing consistent catalyst uptake of 230±5 mg/g and 99.3±0.8% regeneration efficiency across a range of commonly employed electrolytes (FIG. 17c). Many industrial catalytic systems use ionic catalyst promoters and co-catalysts. For the case of hydrosilylation, aluminum chloride and lithium chloride are two such catalyst stabilizing promoters. PVF-adsorption remained selective to Speier's catalyst while in the presence of 20-fold excess of competing LiCl and AlCl₃ ionic hydrosilylation promoters, without hindering catalyst uptake (LiCl: 234 mg/g, AlCl₃: 213 mg/g) or recovery efficiency (LiCl: 99.9%, AlCl₃: 99.6%).

Generality to platinum group metal recovery. Lastly, we evaluated PVF-CNT recovery performance with a range of PGM chloro-anions of value: RuCl₅NO⁻², RhCl₆⁻³, PdCl₄⁻², IrCl₆⁻², and PtCl₆⁻², many which are pre-catalysts or catalysts for homogeneous reactions themselves. Electrosorption of 1 mM for each PGM salt (0.5 V vs Ag/AgCl, 30 minutes) resulted in a significant uptake of all target PGMs in FIG. 5c, with palladium achieving the highest (0.21 mol metal/mol ferrocene) and rhodium with the lowest (0.07 mol metal/mol ferrocene). Electrochemical release was also successful for all PGM anions, achieving a recovery efficiency of 73% with ruthenium, and a 100% recovery efficiency with iridium and platinum. These results demonstrate the generality of the electrochemical recycling approach beyond Pt or Pd, being practical also for other PGM catalysts such as rhodium and iridium, which are key metal centers in homogeneous catalysis.

### Continuous Flow Process Design and Technoeconomic Feasibility

Scale up and flow cell design. A 2-electrode continuous flow-by cell was fabricated with a 16-fold increase in electrode area. Catalyst adsorption was carried out with an applied total cell potential of +2.0 V and desorption at −2.0 V, with operation based on optimal conditions from previous 3-electrode experiments. A 1 mM Speier's catalyst in ethanol solution flowed through the flow-by cell at 1.0 ml/min. Inline ICP measurements of atomic platinum concentration was recorded downstream of the flow-by cell with 1 second resolution (FIG. 4a). The flow-cell achieved a maximum cumulative uptake of 151 mg/g within 6 minutes, and release of 95% of adsorbed Speier's catalyst within 4 minutes (FIG. 4c), in agreement with batch performance. 0.7 kJ/g-PVF energy was consumed during electrosorption and 0.55 kJ/g-PVF during electro-release (FIG. 4b). The flow-cell results showed that scaleup of the PVF-CNT catalyst recycle system was feasible with no loss of performance and could even successfully concentrate the catalyst from 162 ppm to 255 ppm upon release (FIG. 23).

Technoeconomic Analysis. A comparative technoeconomic analysis of the PVF adsorption system was performed vs competing catalyst recovery techniques, namely distillation and electrodeposition (FIG. 5g). Distillation is the predominant catalyst recovery technique in industry, and electrodeposition is a major metal recovery process in hydrometallurgy. Our system was modeled as a fully continuous separation process (FIG. 5d), where two electrochemical recycling units operate in alternating fashion. For hydrosilylation using 20 L/min product stream with 100 mg/L of Speier's catalyst as the basis, the cost of redox-mediated electrosorption was conservatively estimated at $49,912/yr, being the most economical catalyst recovery method by a significant margin. Distillation and electrodeposition had 460% and 660% higher costs, respectively. In addition, electrosorption consumed 99.78% and 99.84% less energy than distillation and electrodeposition respectively. The low energy demand of electrosorption (0.38 kWh) could be easily met with renewable sources, such as single solar cell with a footprint of 60 cm×60 cm (0.38 m²). Finally, the active catalyst can often be destroyed during distillation and electrodeposition, raising the costs. Synthesizing new Karstedt's catalyst was estimated to cost 271% more per year than the total cost of sourcing PVF, clearly demonstrating the economic advantage of catalyst recycling. In sum, electrochemical recovery of homogeneous catalysts is remarkably superior to current methods from an economic, energy, and sustainability standpoint.

### Conclusion

Here, we develop redox-active electrosorbent platforms for the capture and release of key classes of homogeneous catalysts, namely for hydrosilylation, silane etherification, Wacker oxidation, and Suzuki cross-coupling. Through functionalization of electrode surfaces with a redox-metallopolymer and judicious tuning of sorption and release potentials, irreversible electrodeposition of the platinum group metals is avoided, and full preservation of catalytic activity is achieved for a broad scope of substrates, solvents, and competing species. The role of charged catalytic species was investigated by spectroscopic methods and electronic structure calculations during the catalyst recycling process. Translation of our redox-system to continuous flow processes showed preservation of uptake capacity and regeneration efficiency compared to the batch results. Going forward, we envision the concept of electrochemical recycling to be generalized to broader classes of homogeneous catalysts. With the gradual shift towards electrification and the new paradigm for reduce, reuse, and recycle, electrochemical catalyst recovery can play a key role in ushering sustainable and resource-friendly chemical manufacturing and process synthesis.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1. Materials and Methods

Instruments and Reagents. Karstedt's catalyst solution was obtained from Gelest and Polyvinyl ferrocene was obtained from Polysciences, Inc. All chemicals were obtained from Sigma Aldrich, VWR, Fisher Scientific Acros, Alfa Aesar or TCI, and used as received, unless otherwise stated. The nuclear magnetic resonance (NMR) spectra were obtained using a UNITY 500 NB (500 MHz; 5 mm Varian 1H PFG Z probe) (Varian, USA). MestReNova14.1.0 was used to analyze all spectra. Electrospray-ionization mass spectrometry (ESI-MS) was performed with a Waters Q-TOF Ultima ESI or a Waters GCT Premier orthogonal acceleration time-of-flight (oa-TOF) mass spectrometer. The surface morphologies and elemental mapping images of the electrodes were obtained using a scanning electron microscope (SEM; Hitachi S-4700) operated at an accelerating voltage of 10 kV, equipped with energy dispersive X-ray spectroscopy (EDS; iXRF) with the accelerating voltage of 15 kV. The chemical states of iron and platinum on the electrodes were characterized using X-ray photoelectron spectroscopy (XPS; Kratos Axis ULTRA) with monochromatic Al Kα X-ray source (210 W). The XPS results were analyzed using CASA XPS software (UIUC license). The spectra were fitted into their components following subtraction of a Shirley background from the region of interest. Parameters for curve-fitting of Pt 4f, Pd 3d, and Fe 2p were determined from reported literature (Surf Sci 1984, 145, 239). The ToF-SIMS spectra were obtained using a PHI TRIFT III (Physical Electronics, USA) equipped with a liquid metal ion gun that bombards gold ions. For the detection of negative Pt complexes, the second ion beam of Cs⁺ was used at 150-250 nA with an acceleration voltage of 2 kV. Flash chromatography was performed using a Büchi Pure C-810 chromatography system with Büchi Pureflex Ecoflex silica cartridges as stationary phase.

PVF-CNT electrode synthesis. PVF-CNT ink solution was prepared using previously reported methods (Tunable Zn1-xMgxO Thin Films as Highly Transparent Cathode Buffer Layers for High-Performance Inverted Polymer Solar Cells. Adv Energy Mater 2014, 4). 80 mg of poly (vinyl) ferrocene and 40 mg of vacuum-dried multiwalled carbon nanotubes (MWCNTs) were added to 10 ml chloroform to make solution “A”. A separate solution “B” was simultaneous prepared containing 40 mg of MWCNTs in 10 ml of chloroform. Both Solutions A and B were sealed and ultrasonicated at a temperature less than 15 degrees Celsius for 30 minutes. Post sonication, solutions A and B are combined and sonicated a second time at a temperature less than 15 degrees Celsius for 30 minutes. PVF-CNT ink solution containing 4 g/L PVF and 4 g/L MWCNT was then applied to a current collector to produce a PVF-CNT electrode. 0.03″ thick 316 stainless steel sheet (McMaster Carr), 0.001″ thick graphene (McMaster Carr), and Toray 030 carbon paper were used as the current collector materials and cut into 1 cm by 3 cm strips; stainless steel sheets were lightly sanded with 120 grit sandpaper for better coating adherence. 50 ul of PVF-CNT ink was drop coated onto the current collector and spread to cover a 1 cm-by-1 cm area using a pipette tip. The PVF-CNT coated electrode was left to dry from benchtop at room temperature and yielded a 0.4 mg PVF-CNT coating consisting of 0.2 mg of PVF.

For the solvent versatility test in FIG. 18, 1,3-Benzenedisulfonyl azide was synthesized based on a method in a literature (J Appl Polym Sci 2001, 79, 1092). It was added to the PVF-CNT ink solution as a crosslinker (20 w % of PVF) to prevent the dissolution of PVF in organic solvents (i.e., N-dimethylformamide (DMF), acetonitrile (MeCN), acetone, and tetrahydrofuran (THF)). After following the same coating procedure above, the coated electrode was put into an oven and crosslinked at 160° C. for 1.5 hour.

Analytical batch cell experimentation. Adsorption/desorption batch cell experiments were conducted with 3D-printed electrochemical batch cells. The 3D-printed batch cells were designed in-house to maximize the electrode area to solution volume (typ. 1 cm2/mL), maintain consistent geometry between working and counter electrode (parallel spacing of 1 cm2), and inhibit organic solvent evaporation. All printed parts were constructed with polypropylene on a PRUSA Research i3 MK3S direct-drive fused deposition modelling (FDM) 3D-printer with a layer thickness of 0.1 mm and 100% infill. All adsorption/desorption experiments were conducted in a printed cell containing a 1 cm by 3 cm PVF-CNT working electrode, 1 cm by 3 cm plain carbon paper counter electrode, a reference electrode (either aqueous Ag/AgCl or nonaqueous AgCl), and a small stir bar. The cells were filled with 1mL of analytical solution (1 mM Speier's Catalyst and 20 mM Tetrabutylammonium perchlorate (TBAP) in ethanol unless otherwise specified) which contacted the lower 1 cm by 1 cm of each electrode and then were sealed with a 3D-printed cap. Electrochemical experiments were conducted with BioLogic SP-200 single-channel Potentiostat. Unless otherwise specified, +0.5 V vs Ag/AgCl was applied onto the PVF-CNT electrode for 30 minutes for electrosorption. Regeneration of PVF-CNT redox electrode was accomplished by applying +0.1 V vs Ag/AgCl onto the PVF-CNT electrode for 30 minutes in clean 20 mM TBAP solution (unless another supporting electrolyte is specified).

Electrode cyclability experiment. A cycle consisted of rapid chronopotentiometric charging at +4 A/g-polymer (+10 A/m²) until the two-electrode potential reached 2.15 V followed by rapid chronopotentiometric discharging at −4 A/g-poly until a potential of −2.45 V was reached, and after 4671 charge/discharge cycles, the cell energy capacity only decreased by 15% to 50.8 mAh/g-PVF.

Analysis of total Pt and Pd in solution. The concentration of total dissolved Pt within solution was quantified using inductively coupled plasma optical emission spectroscopy (ICP-OES, Agilent 5110). A 5 wt. % HCl dilution solution was prepared from 38% HCl (Fisher Scientific) and used to dilute calibration standards and aqueous samples. Four standard solutions were prepared for both Pt and Pd by diluting the ICP calibration standard (Platinum standard for ICP TraceCERT®, 1000 mg/L Pt in hydrochloric acid, Sigma-Aldrich and Palladium standard for ICP TraceCERT®, 1000 mg/L Pd in hydrochloric acid) with the 5 wt. % HCl dilution solution. After calibration, the linear fit was visualized, ensuring R² of >0.999 for every measurement. Silane containing samples were prepared for ICP-OES by drying 100 μL of sample in a vacuum oven at 100° C. until complete evaporation, and the solid platinum was then digested in 1 ml of aqua regia (3 ml HCL to 1 ml HNO₃) and diluted with 4 ml of DI water after an hour of digestion. Each sample was measured with at least ten replicates by spectrometer to yield a reliable averaged reading. 100 μL Samples containing PdCl₂(PPh₃)₂ for cross-coupling experiments were digested in 1 mL aqua regia, vortex mixed for 30 seconds, and diluted with 9 mL of DI water.

Pt(0) and Pt(II) species uptake calculation. ICP was used to determine the concentration (RSD<1%) change of total platinum (0,II, and IV) in solution after adsorption and desorption. ICP was also used to determine the total Pt on the working and counter electrode via aqua regia digestion of the electrode after adsorption—this allowed accurate measure of the fraction of Pt accumulation on the working electrode (vs the counter electrode). XPS analysis was used to determine the oxidation state of accumulated Pt on the working and counter electrodes, and the relative fraction of Pt(II) in a single sample was accurately determined with the Pt(0), Pt(II), and Pt(IV) peak areas. Therefore, The uptake of Pt(II) on both working and counter electrode was calculated using the following equation:

$${q}_{WE}^{Pt ( II )} = {q}_{tot}^{Pt} * [ \frac{Δ {m}_{WE}^{Pt}}{Δ {m}_{WE}^{Pt} + Δ {m}_{CE}^{Pt}} * \frac{{A}_{WE}^{Pt ( II )}}{{A}_{WE}^{Pt ( 0 )} + {A}_{WE}^{Pt ( II )} + {A}_{WE}^{Pt ( IV )}} + \frac{Δ {m}_{CE}^{Pt}}{Δ {m}_{WE}^{Pt} + Δ {m}_{CE}^{Pt}} * \frac{{A}_{CE}^{Pt ( II )}}{{A}_{CE}^{Pt ( 0 )} + {A}_{CE}^{Pt ( II )} + {A}_{CE}^{Pt ( IV )}} ]$$

### Where:

qₜₒₜ^{Pt} is the total uptake of atomic Pt—from ICP;
Δm_{WE}^{Pt}, Δm_{CE}^{Pt} are the changes of atomic Pt mass found on the working and counter electrodes after digestion in aqua regia—from ICP; and
A_{WE}^{Pt(0)}, A_{WE}^{Pt(II)}, A_{WE}^{Pt(IV)} are the uncoupled oxidation peak areas for Pt(0,II, and IV) observed on the working electrode (same for the counter electrode, CE)—from XPS.

Flow-by cell and inline ICP. The Flow-by cell used in this work consisted of two carbon paper electrodes (active area of 4 cm by 4 cm) sealed between acrylic backing plates with a 1/32″ Viton rubber gasket. A Teflon mesh was placed between electrodes to increase turbulence and reduce the cell's internal volume to 1 mL. Titanium current collectors mechanically and electrically supported the PVF-CNT coated carbon paper working electrode and plain carbon paper counter electrode. No reference electrode was used with the flow-by cell. The 4 cm-by-4 cm PVF-CNT coated carbon paper electrode was produced using the same method as batch cell electrodes, where 0.8 ml of PVF-CNT ink solution was drop coated via pipette to fully cover a 4 cm-by-4 cm carbon paper sheet.

Fresh analytical solution was continuously pumped to the flow-by cell with a Longer peristaltic pump located upstream of the cell. Downstream of the flow-by cell, the stream is auto-diluted with a two-channel peristaltic pump, and the diluted stream is sent directly to the ICP-OES for immediate analysis. Auto-dilution is carried out by pumping the flow cell stream with a 0.5 mm diameter peristaltic tube in the first channel, pumping 5% HCl in DI water with a 3.17 mm diameter peristaltic tube with the second channel of the same pump, and combining the two streams. Dilution ratio (Initial Pt concentration/diluted Pt concentration) was controlled by the two different tube diameters, and 40:1 dilution was maintained.

Electrochemical stability test in various solvents. The ferrocene (II/III) couple was used for a reference potential. To determine the half potential of the ferrocene in each organic solvent, cyclic voltammetry of 6 cycles at 20 mV/s (−0.5-1.0 V vs. Ag/Ag⁺) was used in 3 mL of 1 mM ferrocene 20 mM TBAPF₆ (1×1 cm carbon paper working, Pt wire counter, and nonaqueous Ag/Ag⁺ reference). The half potential was calculated by averaging the oxidation and reduction peak potentials at the second cycle. For water, the half potential value was adapted from literature (J Phys Conf Ser 2014, 557). The half potential of PVF on a PVF-CNT electrode was determined with the same cyclic voltammetry setting above (−0.7-1.0 V vs. Ag/Ag⁺) in 3 mL of 20 mM TBAPF₆ (1×1 cm PVF-CNT working, carbon paper counter, and nonaqueous Ag/Ag⁺ reference). The half-potential was calculated by averaging the oxidation and reduction peak potentials at the fifth stable cycle. For DMF, MeCN, acetone, and THE, crosslinked PVF-CNT electrodes were used. The cumulative charge of each cycle in FIG. 18 was calculated by calculating the difference between the maximum and minimum charge and then normalized by the cumulative charge of the second cycle as the very first cycles were disregarded. To obtain the potential stability window of organic solvents, current vs. the counter potential (carbon paper) from the above PVF-CNT cyclic voltammograms was plotted for DMF, MeCN, acetone, and THE while another cyclic voltammetry (−2.5-2.5 V vs. Ag/Ag⁺) was taken for EtOH and MeOH with 20 mM TBAPF₆ (1×1 cm carbon paper working. Pt wire counter, and nonaqueous Ag/Ag⁺ reference). The oxidation and reduction onset potential of each solvent was calculated by obtaining an intersection between the current baseline and the tangent line of oxidative and reductive current, respectively. The onset potential of Pt electrodeposition with Speier's Catalyst was determined by cyclic voltammetry at 50 mV/s (−1.0-0.5 V vs. Ag/Ag⁺) in 1 mM Speier's Catalyst 0.1 M TBAPF₆ (1×1 cm carbon paper working, Pt wire counter, and nonaqueous Ag/Ag⁺ reference). The Pt electrodeposition onset potentials were calculated in the same way used for the onset potentials of solvent oxidation and reduction.

### Example 2. Reaction Recycling Procedures

Silane etherification reaction procedure. Speier's catalyst was synthesized by adding 50 mg of hexachloroplatinic acid (CPA) to 1 ml of anhydrous isopropanol and stirred for 30 minutes. Due to the highly hygroscopic nature of dry CPA, it was handled and massed within a glovebox. The 50 g/L Speier's catalyst solution was stored in a UV resistant vial and kept refrigerated to inhibit the chance of degradation. Typical Silane etherification reactant solution consisted of 1 mL triethylsilane (TES) 2 mL ethanol, and 20 mM of tetrabutylammonium perchlorate (TBAP). The concentration of silane within the reactant solution was maintained for all experiments to 2.09 mol/L. The silane etherification reaction was carried out within 3D-printed polypropylene electrochemical cells containing 1.2 mL reactant solution at room temperature with stirring, and the typical reaction time was 30 minutes. The reaction was initialized by one of two methods; the first method was by direct addition of catalyst solution (called the control or initialization reaction), and the second method of reaction initialization was by electrochemical release of catalyst from PVF-CNT electrode (called the experiment or cycled reaction). For a control reaction, either 50 mg-Pt/L Speier's catalyst or 100 mg-Pt/L Karstedt's catalyst (2% Pt in xylene as received) was used. As the Silane etherification reaction progressed, hydrogen gas was released, and bubbles were visibly seen and used as a general heuristic for reaction progress. Reaction products were identified using both H¹NMR, GC-MS, and ESI-LCMS, and reaction yield was calculated from H¹NMR data. For select experiments, reaction kinetics were determined by taking periodic H¹NMR aliquots. NMR data are consistent with literature values.

Triethyl ethoxysilane was isolated from the reaction mixture by removing the solvent under reduced pressure and subsequently purified by distillation at 156 mbar. Yielding 3.059 g (38%) CH₃CH₂OSiEt₃ as a colorless liquid for a reaction with fresh catalyst, and 1.160 g (35%) for a reaction using recycled catalyst.

CH₃CH₂OSiEt₃. H¹ NMR (CDCl₃, 500 MHz) δ (ppm): 3.65 (q, J=7.2 Hz, 2H, CH2), 1.15 (t, J=7.2 Hz, 3H, CH3), 0.93 (t, J=8.5 Hz, 9H, SiEt), 0.57 (q, J=8.5 Hz, 6H, SiEt). HR-ESI m/z: [M]⁺ calcd. for C₈H₂₀SiO, 160.1283; found: 160.1285.

CH₃OSiEt₃. H¹ NMR (CDCl₃, 500 MHz) δ (ppm): 3.36 (s, 3H, H₃CO—), 0.96 (t, J=8.0 Hz, 9H, SiCH2CH3) 0.57 (q, J=8.0Hz, 6H, SiCH₂CH₃).

i-PrOSiEt₃. H¹ NMR (CDCl₃, 500 MHz) δ (ppm): 4.12 (septet, J=6 Hz, 1H), 1.28 (d, J=6Hz, 6H), 1.14 (m, 9H, overlapped with Et₃SiH), 0.75 (m, 6H, overlapped with Et₃SiH).

CH₃CH₂OSiMe₂Ph. H¹ NMR (CDCl₃, 500 MHz) δ (ppm): 7.60-7.55 (m, 2H, Ph), 7.40-7.35 (m, 3H, Ph), 3.68 (q, J=7.14 Hz, 2H, CH₃CH₂), 1.19 (t, J=7.14 Hz, 3H, CH₃CH₂), 0.39 (s, 6H, SiMe).

Hydrosilylation reaction procedure. Typical hydrosilylation reaction solution consisted of 1 mL TES as the silane, 1 ml of Phenylacetylene as the olefin, 1 ml of acetonitrile as solvent, and 20 mM TBAP as supporting electrolyte and competing ion. Reactant solution was made fresh for each experiment and stored in refrigerator when not in use. Hydrosilylation reactions were carried out in a Teflon-capped amber glass vial (containing 1.2 mL of reactant solution) at 50° C. with stirring for 24 hours. Like the silane etherification procedure, hydrosilylation was initiated either by direct addition of catalyst (control reaction) or electrochemical release of captured catalyst from PVF-CNT electrode (cycled reaction). In the case of the control reaction, either 100 ppm Speier's catalyst or 200 ppm Karstedt's catalyst was used. For the cycled reaction, the reaction is first initialized in a 3D-printed electrochemical cell where catalyst is released, and after 30 minutes the solution is transferred to a Teflon-capped amber glass vial for the remaining 23.5 hours. Reaction products were identified using both H¹ NMR and ESI-LCMS, and reaction yield was calculated from H¹NMR data. NMR data are consistent with literature values.

H¹ NMR (500 MHZ, CDCl₃) δ (ppm): 0.63 (q, J=7.4 Hz, 6H, CH₂CH₃), 0.97 (t, J=7.4 Hz, 9H, CH₂CH₃), 6.45 (d, J=19.3 Hz, 1H, ═CH), 6.92 (d, J=19.3 Hz, 1H, ═CH), 7.15-7.19 (m, 1H, Ph-H), 7.22-7.35 (m, 3H, Ph-H), 7.45-7.49 (m, 1H, Ph-H). ESI m/z: [M]⁺ calcd. for C₁₄H₂₂Si, 218.1491; found: 218.1496.

For all hydrosilylation electrochemical recycling experiments a non-aqueous Ag/Ag⁺ reference electrode was used. Optimal adsorption and desorption values obtained with reference to Ag/AgCl were translated to non-aqueous reference using the observed standard potential of PVF from CV as an intermediate reference.

Triethyl(phenylvinyl) silane was isolated from the reaction mixture by diluting the reaction mixture with diethylether. The organic phase was washed with water and brine. Afterward, the organic phase was dried with MgSO₄ and the solvent was evaporated after filtration. The product was purified by flash chromatography (silica column and Hexane/CH₂Cl₂ gradient). Yielding 810 mg (81%) of a mixture of 78% triethyl (2-phenylvinyl) silane and 22% triethyl (1-phenylvinyl) silane as a slightly yellow liquid for a reaction with fresh catalyst, and 670 mg (67%) of a mixture of 76% triethyl (2-phenylvinyl) silane and 24% triethyl (1-phenylvinyl) silane for a reaction using recycled catalyst.

H¹ NMR (CD₂Cl₂, 500 MHZ) δ (ppm): 7.47 (d), 7.36-7.17 (m), 6.94 (d.), 6.48 (d), 5.89 (d), 5.61 (d), 1.03 (t), 0.96 (t), 0.71 (q). HR-ESI m/z: [M]⁺ calcd. for C₁₄H₂₂Si, 218.1491; found: 218.1496.

Wacker oxidation reaction procedure. For control reactions using as-received catalyst, a 12 mL 7:1 (by vol) methanol/water solution containing 10 mM PdCl₂, 200 mM CuCl₂, 50 mM chlorobenzene and 500 mM 2-vinylnapthalene was prepared. A reactor containing the reactant solution was heated to 80° C. purged and pressurized up to 5 bar with pure oxygen and stirred at 800 rpm. The reaction ended after 8 hr. For an electrochemically recycled reaction. 10.1 mL 7:1 (by vol) methanol/water solution containing 1.49 mM recycled PdCl₂, 29.8 mM CuCl₂, 50 mM chlorobenzene, 20 mM LiCl and 500 mM 2-vinylnaphthalene was prepared. The reactant solution was purged with pure oxygen and sealed in a pressure reaction vessel. The stirred vessel was heated to 80° C., purged, and pressurized to 5 bar with pure oxygen. The reaction ended after 24 hr.

For both control reaction and electrochemically recycled reaction, recovery of the catalyst used 6 mL of the product solution (10 mM PdCl₂, 200 mM CuCl₂, 50 mM chlorobenzene and products in 7:1 (by vol) methanol/water) for adsorption and 6 mL of 20 mM LiCl for desorption. Each 6 mL solution was divided into three 3D-printed electrochemical batch cells (2 mL for each cell). Three PVF-CNT electrodes coated on both sides (0.4 mg of PVF-CNT total) were put together as one working electrode while three carbon paper electrodes were used as one counter electrode along with Ag/AgCl reference. After the catalyst electrosorption at 0.6 V vs. Ag/AgCl for 20 min, the same three electrode configuration containing the three catalyst-laden PVF-CNT electrodes was transferred into 2 mL of 20 mM LiCl in 7:1 (by vol) methanol/water. The adsorbed catalyst was released at 0.1 V vs. Ag/AgCl for 20 min. This adsorption-desorption cycle was repeated 3 times for each 2 mL cell. The ICP-OES showed that 25.8% PdCl₂ (20.1 ppm Pd) was recovered from the control reaction solution. To obtain sufficient amount of an isolated product from the electrochemically recycled reaction, the Pt-recovered solution was scaled up by diluting the recovered catalyst solution with 7:1 (by vol) methanol/water solution to make 10.1 mL of 1.49 mM PdCl₂. Afterwards, CuCl₂, chlorobenzene, and 2-vinylnaphthalene were added to make the reactant solution composition mentioned above.

2-Acetonaphtone was isolated from the reaction mixture by diluting the reaction mixture with diethylether. The organic phase was washed with water and brine. Afterward, the organic phase was dried with MgSO₄ and the solvent was evaporated after filtration. The product was purified by flash chromatography (silica column and Hexane/CH₂Cl₂ gradient). Yielding 215 mg (41%) 2-acetonaphtone as a slightly yellow liquid for a reaction with fresh catalyst, and 210 mg (40%) for a reaction using recycled catalyst.

H¹ NMR (CD₂Cl₂, 500 MHZ) δ (ppm): 8.48 (s, 1H), 8.01 (m, 2H), 7.91 (m, 2H), 7.52 (m, 2H), 2.70(s, 3H). HR-ESI m/z: [M+H]⁺ calcd. for C₁₂H₁₁O, 171.0810; found: 171.0809.

Suzuki cross-coupling reaction procedure. 250 mM 4-bromoacetophenone, 350 mM phenylboronic acid, 500 mM sodium acetate, and 250 mM tetrabutylammonium bromate were added to 10:1 (by vol) ethanol/water, and the reactant solution was purged with nitrogen. For control reactions with as-received catalyst, 0.1 mM PdCl₂(PPh₃)₂ was added from a 10 mM stock solution in DMF. For electrochemically recycled reactions, a catalyst laden PVF-CNT electrode, reference electrode, and carbon paper counter electrode were added to the Suzuki reactant solution and a constant potential of 0.1V vs Ag/AgCl was applied for 30 minutes. After catalyst was added to reactant solution, a stir bar was added, and the reaction vial was sealed. Timing of the reaction began when the sealed reaction vial was placed in a stirred oil bath at 80° C.

4-Acetylbiphenyl was isolated from the reaction mixture by diluting the reaction mixture with diethylether. The organic phase was washed with water and brine. Afterward, the organic phase was dried with MgSO₄ and the solvent was evaporated after filtration. The product was purified by flash chromatography (silica column and Hexane/CH₂Cl₂ gradient). Yielding 120 mg (61%) 4-acetylbiphenyl as a colorless solid for a reaction with fresh catalyst, and 66 mg (67%) for a reaction using recycled catalyst.

H¹ NMR (CD₂Cl₂, 500 MHZ) δ (ppm): 8.02 (d, 2H), 7.72 (d, 2H), 7.66 (d, 2H), 7.48 (t, 2H), 7.41 (t, 1H), 2.61 (s, 3H). HR-ESI m/z: [M+H]⁺ calcd. for C₁₄H₁₃O, 197.0966; found: 197.0964.

Catalyst recycling procedure. A catalyst recycling experiment begins with an NMR sample of the reactant solution followed by an initialization reaction where known amount of catalyst is manually pipetted into a reactant mixture. For silane etherification, the reaction is considered complete once hydrogen bubbling completely stops (typ. 5 to 10 minutes), and for hydrosilylation, the reaction is always stopped after 4 hours. Once the initialization reaction was stopped, reaction time was recorded, a second NMR sample was taken, and an ICP sample was taken. The initialization reaction product solution was then added to a three-electrode electrochemical cell where catalyst was adsorbed by an applied potential of +0.5V vs Ag/AgCl to the PVF-CNT electrode for 30 minutes at room temperature and with stirring. After adsorption, the electrodes were removed (PVF-CNT working, carbon paper counter, and reference) and a second ICP sample was taken. A second electrochemical cell was then filled with 1 mL of reactant solution and the electrodes (with catalyst adsorbed) were added. The second reaction, known as the cycled reaction, was initialized by an applied potential of +0.1V vs Ag/AgCl to the PVF-CNT electrode for 30 minutes. After catalyst desorption, a third ICP sample and third NMR sample is taken of the solution once the reaction completes, concluding the experiment. Product identification is done with ESI-LC-MS and NMR analysis of both initialization reaction and cycled reaction. Reaction yield was determined by quantitatively comparing NMR samples of before and after reaction.

Silane etherification reaction electrode cycling experiment procedure. Electrode durability was tested by running the catalyst recycling procedure (above) where Speier's catalyst is electrochemically recycled in a TES etherification reaction with ethanol. This catalyst recycling experiment was repeated in its entirety multiple times reusing the same PVF-CNT working and carbon paper counter electrodes in each cycle. After the PVF-CNT working and carbon paper counter electrodes were cycled through 7 iterations of catalyst recycle, the electrodes were kept for XPS analysis. To make each recycle test consecutive, only 7 cycles were possible in a single day.

### Example 3. Operating Conditions

Disclosed technology has been tested and shown to achieve the following:
1. Adsorb a homogeneous noble-metal catalyst complex from a solution to an electrode surface.
   Remove an active catalyst from a completed reaction solution with >200 mg/g-adsorbent. Selectively remove only the active catalyst (with a selectivity factor >10) without removing other ions or solvent.
2. Desorb the adsorbed catalyst complexes into a new solution.
   Catalyst released into a reactant solution catalyzes a new reaction with the same activity of new catalyst—the catalyst is fully recycled.
   >99.5% of adsorbed catalyst was released.
   Increasing concentration of catalyst is possible.
3. The catalyst is captured and released without chemically altering the catalyst species—the catalyst activity is left intact. This saves time and money because no catalyst regeneration step is required before the catalyst can be reused.
4. The disclosed system requires only electrical input to operate and can rapidly switch between adsorption and desorption within about a minute or less.
5. The disclosed system is energy efficient compared to conventional methods and requires 0.2% of the energy demand of distillation. The energy efficiency pairs well with point-source renewable energy sources such as solar.
6. The disclosed system has been shown robust over 5000 cycles with no loss in catalyst recyclability.
7. The disclosed system is scalable and configurable into a continuous flow system.

### Configuration of Working Electrode

Current collector: Teflon coated carbon paper (preferred), graphite, graphene sheet, titanium, stainless steel.
Redox polymer: Polyvinylferrocene (preferred), poly 2-(methacryloyloxy) ethyl ferrocenecarboxylate (PFcMA).
Conductive binder: Multiwalled carbon nanotubes. Various mass ratios of Poly:CNT were tested and shown to work. A ratio of 1:1 was typically used.
Size: 1 cm by 1 cm and 4 cm by 4 cm were tested but can be any size.

### Configuration of Counter Electrode

Current collector: Teflon coated carbon paper (preferred), graphite, graphene sheet, titanium, stainless steel.
No polymer coating (i.e., bare material).
Size: 1 cm by 1 cm and 4 cm by 4 cm were tested but could be any size.

### Adsorption/Desorption Solution

Solvent: ethanol, methanol, isopropanol, acetone, acetonitrile, DMF, and water were tested; various conditions for hydrosilylation and silane etherification were tested. Various conditions are compatible and can be tailored to fit the process.
Catalyst: chloroplatinic acid, Speier's catalyst (chloroplatinic acid-isopropanol complex), Karstedt's catalyst were tested. Various other platinum complexes are possible.
Catalyst concentration: as low as 6 mg/L and as high as 400 mg/g catalyst was successfully tested. Lower and higher concentrations are possible.
Supporting electrolyte: aluminum chloride, lithium chloride, sodium perchlorate, lithium perchlorate, and tetrabutylammonium perchlorate were tested. Other salts or combinations of salts are possible. Supporting electrolyte concentration: from 10 mM to 100 mM were tested. Electrically conductive solutions at lower and higher concentrations are possible.

### Adsorption/Desorption Cell

Minimum configuration comprises one PVF-CNT working electrode, one counter electrode, liquid catalyst containing solution (still or flowing), and optionally a reference electrode.

Disclosed system has been shown to work for both batch and continuous flow operation. 3D-printed cells were used to maintain constant electrode geometry and inhibit solvent evaporation. Other configurations with the above features are possible.

### Electrical Input for Adsorption

Adsorption can be carried out by the application of a constant potential or constant current in a 3-electrode or 2-electrode cell configuration.
Constant potential (chronoamperometry): an applied voltage of +0.4V to +1.0V vs Ag/AgCl is possible. Preferably +0.5V for inhibiting catalyst degradation at the counter electrode and reducing other side reactions to minimize wasted energy.
Constant Current (chronopotentiometry): an applied current above 1 A/g-PVF is possible. Preferably 4 A/g-PVF for inhibiting catalyst degradation at the counter electrode and reducing other side reactions to minimize wasted energy.
Adsorption time: typically, the PVF-CNT electrode will achieve maximum uptake within as low as 5 minutes. This parameter can be tuned by adjusting applied current and electrode dimensions.

### Electrical Input for Desorption

Desorption can be carried out by the application of a constant potential or constant current in a 3-electrode or 2-electrode cell configuration.
Constant potential (chronoamperometry): an applied voltage of −0.2V to +0.3V vs Ag/AgCl is possible. Preferably +0.1V for inhibiting catalyst degradation at the working electrode and reducing other side reactions to minimize wasted energy.
Constant Current (chronopotentiometry): an applied current above −1 A/g-PVF is possible. Preferably −4 A/g-PVF for inhibiting catalyst degradation at the working electrode and reducing other side reactions to minimize wasted energy.
Desorption time: typically, the PVF-CNT electrode will achieve maximum catalyst release within as low as 5 minutes. This parameter can be tuned by adjusting applied current and electrode dimensions.

### Catalyst Recycling Under Reaction Conditions

Disclosed system was tested by directly adsorbing catalyst from a completed chemical reaction and then releasing the adsorbed catalyst into a solution of reactants to catalyze a new chemical reaction.

For the following reaction types, the catalyst was successfully adsorbed from products, the catalyst was successfully desorbed to reactants, and the released catalyst maintained its original catalytic activity to successfully catalyzed a new reaction.
Hydrosilylation: Triethylsilane+phenylacetylene→products (other hydrosilylation reactions are also possible).
Silane etherification: Triethylsilane+ethanol à products; Triethylsilane+methanol à products; Triethylsilane+isopropanol à products; Triethylsilane+diacetone alcohol à products; Dimethylphenylsilane+ethanol à products (other silane etherification reactions are also possible).

Other reactions using platinum complex catalysts are possible, including cross-coupling and olefin oxidation. A metal species (charged or uncharged) including palladium, iridium, ruthenium, rhodium and other noble metals used for homogeneous catalysts, or otherwise, that can bind to the disclosed working electrode, are examples of metal catalysts that can be recycled.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. A method for electrochemically recycling a noble metal catalyst comprising:
a) applying a positive first potential to a working electrode comprising a redox metallopolymer wherein the metal moieties of the redox metallopolymer are transformed to an oxidized metal species and form an oxidized metallopolymer electrode;
b) contacting a product mixture and the oxidized metallopolymer electrode wherein the mixture comprises a reaction product and a noble metal catalyst;
c) selectively adsorbing the catalyst to the oxidized metallopolymer electrode wherein the noble metal moiety of the catalyst binds to the oxidized metal species and forms a loaded electrode;
d) collecting the reaction product when the catalyst is adsorbed to the oxidized metallopolymer electrode;
e) contacting an electrolyte and the loaded electrode;
f) applying a second potential to the loaded electrode wherein the second potential is less relative to the first potential by at least 0.1 V and the oxidized metal species is transformed to a reduced state;
g) desorbing the adsorbed noble metal catalyst from the loaded electrode into the electrolyte; and
h) contacting the desorbed noble metal catalyst and an organic substrate to form the product mixture;
wherein the noble metal catalyst is thereby electrochemically recycled from the reaction mixture.

2. The method of claim 1 wherein the redox metallopolymer is metallocene polymer.

3. The method of claim 1 wherein the metal moieties of the redox metallopolymer are iron or cobalt.

4. The method of claim 1 wherein the redox metallopolymer is a polyferrocene.

5. The method of claim 4 wherein the polyferrocene is polyvinylferrocene (PVF), poly 2-(methacryloyloxy)ethyl ferrocene carboxylate (PFCMA), poly(ferrocenylsilane) (PFS), or poly(ferrocenylmethyl methacrylate) (PFMMA).

6. The method of claim 1 wherein the working electrode comprises a multiwalled carbon nanotube (CNT) binder.

7. The method of claim 1 wherein the working electrode comprises a current collector that is polytetrafluoroethylene coated carbon paper, graphite, graphene sheet, titanium, or stainless steel.

8. The method of claim 1 wherein the first potential is about +0.3 V to about +2.0 V, wherein the first potential is relative to an Ag/AgCl reference electrode.

9. The method of claim 1 wherein the second potential is about −1 V to about +0.3 V, wherein the second potential is relative to an Ag/AgCl reference electrode.

10. The method of claim 1 wherein the noble metal moiety of the noble metal catalyst is platinum, palladium, iridium, ruthenium, rhodium, or osmium.

11. The method of claim 1 wherein the noble metal catalyst is chloroplatinic acid, chloroplatinic acid-isopropanol complex (Speier's catalyst), platinum(0)-1,3-divinyl-1,1,3,3-tetramethyldisiloxane complex (Karstedt's catalyst), PdCl₂, Na₂PdCl₄, PdCl₂(PPh₃)₂, H₃IrCl₆, Na₃RhCl₆, or Na₂RuCl₅NO.

12. The method of claim 1 wherein the noble metal catalyst undergoes electrodeposition to the extent of less than about 5 wt. % of the noble metal catalyst.

13. The method of claim 1 wherein the electrolyte comprises aluminum chloride, lithium chloride, sodium perchlorate, lithium perchlorate, or tetrabutylammonium perchlorate (TBAP), sodium chloride, sodium acetate, CuCl, CuCl₂, tetrabutylammonium chloride, or tetrabutylammonium bromide.

14. The method of claim 1 wherein the electrolyte comprises suitable reactants; and contact of the suitable reactants and the noble metal catalyst forms the product mixture.

15. The method of claim 1 wherein the reaction product is a product of silane etherification, hydrosilylation, cross-coupling, or Wacker oxidation.

16. An electrochemical apparatus for recycling a noble metal catalyst comprising:
a) at least one working electrode, each working electrode comprising a current collector, conductive binder, and a redox metallopolymer wherein the redox metallopolymer is a selective binder and reversible binder of a noble metal catalyst;
b) at least one counter electrode;
c) an electrical power source;
d) a reaction chamber; and
e) a flow inlet and a flow outlet.

17. The apparatus of claim 16 wherein the redox metallopolymer comprises a polyferrocene, and the conductive binder comprises a multiwalled carbon nanotube, single-walled carbon nanotube, activated carbon, graphite, or graphene.

18. The apparatus of claim 16 wherein the current collector and the least one counter electrode each comprise a polytetrafluoroethylene coating.

19. The apparatus of claim 16 comprising a first and second working electrode and a first and second counter electrode, wherein a first cell comprises the first working electrode and one of the first or second counter electrodes, and a second cell comprises the second working electrode and one of the first or second counter electrodes.

20. The apparatus of claim 19 wherein the first and second working electrodes are positioned sequentially and encompass the cylindrical surface of an electrically conductive cylinder that is rotatable on its axis, wherein the cylinder is positioned between the first and second counter electrode.

21. The apparatus of claim 19 wherein the reaction chamber has an inlet in communication with the first cell and an outlet in communication with the second cell.

22. The apparatus of claim 21 wherein the first cell has the flow inlet, and the second cell has the flow outlet.

23. The apparatus of claim 16 wherein the electrical power source is configured to switch or cycle the potential of the working electrode from a first voltage to a second voltage.
